(19) United States
(12) Patent Application Publication
(10) Pub. No.: US 2015/0241237 A1
(43) Pub. Date: Aug. 27, 2015

(54) INFORMATION OUTPUT APPARATUS

(71) Applicant: Kenji Yoshida, Tokyo (JP)

(72) Inventor: Kenji Yoshida, Tokyo (JP)

(21) Appl. No.: 14/191,192

(22) Filed: Feb. 26, 2014

(51) Int. Cl. G01C 21/36; G09B 29/10; G06F 3/0481; G06F 3/0485; G06F 3/03; G06F 3/0354

(52) U.S. Cl. CPC G01C 21/3614; G01C 21/3623; G01C 21/3664; G06F 3/0317; G06F 3/03545; G06F 3/04815; G06F 3/0485; G09B 29/102

(57) ABSTRACT

To realize a user-friendly medium and information output thereof by defining a plurality of information in the same region of a dot pattern printed on a surface of a medium, such as a map or the like, and selectively outputting the information through an imaging operation of an imaging unit. A dot pattern that is printed on a medium to be superimposed on a map or the like includes coordinate information and code information. Therefore, information corresponding to the coordinate information and information corresponding to the code information can be selectively and repetitively output.

### CROSS REFERENCE TO RELATED APPLICATIONS

This application is a continuation application of U.S. patent application Ser. No. 11/991,928 filed on Mar. 13, 2008, and that application is the National Stage of International Application No. PCT/SG2006/000267, filed on Sep. 13, 2006. The disclosures of U.S. patent application Ser. No. 11/991,928 and International Application No. PCT/SG2006/000267 are hereby incorporated by reference.

This application is also based on Japanese Patent Application No. 2005-267565 filed on Sep. 14, 2005, the contents of which are also incorporated hereinto by reference.

### TECHNICAL FIELD

The present invention relates to a medium having printed thereon dot patterns and an information output apparatus thereof.

### BACKGROUND ART

There is known a map, serving as a medium, on which an identifier, such as a barcode or the like, is provided. In a car navigation device, positional data, such as latitude or longitude, is recorded in the identifier on the map. Then, if the identifier is read by a reading unit, it is registered as a destination by the car navigation device. On a display of the car navigation device, a present location, direction and distance to a destination, and the like are displayed (for example, see JP-A-6-103498)

Further, there is suggested an information display method that stores information corresponding to the identifier on the map in a memory of a computer or a memory card and, if the identifier is read by a reading unit, displays the information corresponding to the identifier on an electronic apparatus, such as a computer or a cellular phone. For example, barcodes are printed at tourist attractions on the map and, if a barcode is read, the explanation on a tourist destination is displayed as a video (for example, see JP-A-2004-54465).

Patent Document 1 JP-A-6-103498

Patent Document 2 JP-A-2004-54465

### DISCLOSURE OF THE INVENTION

### Problem that the Invention is to Solve

However, in JP-A-6-103498, it may be impossible to enlarge or reduce the map displayed on the display of the car navigation device and to simply display a place to be displayed other than the present location. In addition, there is a problem flexibility is lacking.

Further, in JP-A-2004-54465, the information obtained from the identifier is limited to the explanation of facilities or the like. That is, it may be impossible to obtain desired information about the map, such as roads around the facilities or the like.

The invention has been finalized in consideration of the above problems, and it is an object of the invention to realize a user-friendly medium and information output thereof by defining a plurality of information in the same region of a dot pattern printed on a surface of a medium, such as a map or the like, and selectively outputting the information through an imaging operation of an imaging unit.

### Means for Solving the Problem

The invention has the following configurations.

According to a first aspect of the invention, an information output apparatus for a medium, on which dot patterns based on predetermined rules are printed in concurrence with printing, includes an imaging unit that reads the dot patterns on a surface of the medium, a converting unit that converts a captured image obtained by the imaging unit into code values or coordinate values indicated by the dot patterns, and an output unit that outputs information corresponding to the code values or the coordinate values. The apparatus has, on at least one surface thereof, a medium where the dot pattern obtained by patterning the coordinate information is superimposed and printed and a multi-information region where the dot pattern obtained by patterning the code information is superimposed and printed on the surface of the medium, together with at least the coordinate information. When the imaging unit reads the coordinate information from the dot pattern in the multi-information region on the surface of the medium, the converting unit reads information associated with the coordinate information from a storage unit, and the output unit outputs the information. Further, when the imaging unit reads the code information from the dot pattern in the multi-information region on the surface of the medium, the converting unit reads information associated with the code information from the storage unit, and the output unit outputs the information.

As such, a dot pattern that has the code information and the coordinate information together is printed on the dot pattern. For example, when the medium is a map, from code information of a symbol on the map, the outline, an image, a motion picture, sound information, and the like of the symbol can be output from a display device or a speaker as the output unit. Further, from the coordinate information on the map and the symbol, a corresponding map image can be output from the display device.

Moreover, the coordinate information may include XY coordinate and a Z coordinate.

Further, unless the entire surface of the medium is the multi-information region where the coordinate information and the code information are printed, when the entire surface of the medium are represented by XY coordinates, only a predetermined region or a symbol portion may include the code information.

According to a second aspect of the invention, in the information output apparatus according to the first aspect of the invention, an icon figure on which a dot pattern for mode switching on whether to read and output information corresponding to the code information read from the dot pattern in the multi-information region from the storage unit or to read and output information corresponding to the coordinate information from the storage unit is printed may be printed on the surface of the medium.

As such, since the icon figure for selecting whether to output the information corresponding to the code information or to output the information corresponding to the coordinate information is printed on the surface of the medium, the information can be selectively output using the imaging unit.

For example, when the medium is a map, and when ‘map icon’ and ‘ information icon’ are printed on the map, if the ‘map icon’ is captured, the coordinate information of the map is read, and thus a corresponding map image can be output from the display device. When the ‘information icon’ is captured, the outline, the image, the motion picture, sound, and the like corresponding to the symbol on the map are output from the output unit, such as a display device or a speaker.

Moreover, printing used herein includes laminating of a seal or a transparent film having printed thereon dot patterns on the surface of the medium, as well as direct printing on the surface of the medium.

According to a third aspect of the invention, in the information output apparatus according to the second aspect of the invention, the coordinate information on the surface of the medium may have at least XY coordinates and a Z coordinate, and the storage unit may store information corresponding to the XY and Z coordinates.

As such, since the Z coordinate is included as the coordinate information, for example, the height of a mountain or a hill, the depth of a sea, a lake, or a pond, or the like on the map can be given as information.

According to a fourth aspect of the invention, in the information output apparatus according to the first aspect of the invention, an icon figure, on which code information for up and down or left and right movement for moving, on the output unit, image information output from the output unit is superimposed and printed, may be further printed on the surface of the medium.

Since such an icon figure is printed and disposed, the image information displayed on the output unit, such as a display device or the like, can be easily moved.

According to a fifth aspect of the invention, in the information output apparatus according to the first aspect of the invention, an icon figure, on which code information for enlarging or reducing, on the output unit, image information output from the output unit is superimposed and printed, may be further printed on the surface of the medium.

Since such an icon figure is printed and disposed, the image information displayed on the output unit, such as a display device or the like, can be easily enlarged or reduced.

According to a sixth aspect of the invention, an information output apparatus for a medium, on which dot patterns based on predetermined rules are printed in concurrence with printing, includes an imaging unit that reads the dot patterns on a surface of the medium, a converting unit that converts a captured image obtained by the imaging unit into code values or coordinate values indicated by the dot patterns, and an output unit that outputs information corresponding to the code values or the coordinate values. The dot pattern obtained by patterning the coordinate information is superimposed and printed on at least one surface of the medium. The medium has a multi-information region where the dot pattern obtained by patterning the code information is superimposed and printed on the surface of the medium, together with at least the coordinate information. When the imaging unit reads the coordinate information and the code information from the dot patterns in the multi-information region on the surface of the medium, the converting unit reads information corresponding to the coordinate information and the code information from a storage unit, and the output unit outputs the information. Output information is switched according to the read operation of the dot pattern on the surface of the medium by the imaging unit.

As such, the output information can be switched according to the read operation of the dot pattern on the surface of the medium by the imaging unit. Therefore, for example, the output information to be output from the output unit can be switched through a simple operation of the imaging unit on the surface of the medium.

More specifically, as described as a seventh aspect of the invention, the switching of the output information may include switching between output information based on the coordinate information and output information based on the code information, switching of the output information in the coordinate information or the code information, or resetting of the output information.

For example, when a map is printed on the surface of the medium, the dot pattern obtained by patterning the coordinate information is printed on the map, and a symbol region obtained by patterning the code information is printed on the map, together with the coordinate information, the switching between the output information based on the coordinate information and the output information based on the code information may include switching between image information, such as a map to be displayed on the display device as the output unit and explanation information (characters, images, sound, and motion pictures) of tourist spots corresponding to the symbol region when the substantially same XY coordinate information or code information in a predetermined time is read multiple times by a grid tapping operation of the imaging unit on the surface of the medium (the symbol region) (an eighth aspect of the invention).

The switching of the output information in the coordinate information may include switching of layers of a map image to be displayed on the output unit (a display device), continuous switching, such as enlargement or reduction, movement of a map screen in XY directions, a dynamic change of a scenery screen having a moved view point in a three-dimensional map or the like, by the read operation of the imaging unit on the surface of the medium (the coordinate information of the map).

The switching in the code information may include switching of the outline, the image, the motion picture, and sound to be displayed on the output unit (a display device or a speaker) by the read operation of the imaging unit on the surface of the medium (the code information on the symbol of the map).

The read operation of the imaging unit on the surface of the medium may be performed when XY coordinate information read in a predetermined time is recognized as a substantially circular trace by a circular grid sliding operation (a ninth aspect of the invention). As such, the output information from the output unit may be switched by an operation of the imaging unit drawing a circle on the surface of the medium.

The read operation of the imaging unit on the surface of the medium may be performed when XY coordinate information read in a predetermined time is recognized as a substantially linear trace by a linear grid scroll operation of the imaging unit on the surface of the medium (a tenth aspect of the invention).

The read operation of the imaging unit on the surface of the medium may be performed when a trace of XY coordinates read in a predetermined time is recognized as a repetition of a linear trace of a short length by a grid scratch operation of the imaging unit (an eleventh aspect of the invention). Further, the read operation of the imaging unit on the surface of the medium may be performed when a grid tilt operation of the imaging unit, that is, an inclination of an imaging optical axis with respect to a vertical line of the surface of the medium is recognized (a twelfth aspect of the invention). In addition, the read operation of the imaging unit on the surface of the medium may be performed when a grid grind operation of the imaging unit, that is, in an inclined state where the imaging optical axis is kept at a predetermined inclination with respect to a vertical line of the surface of the medium, a change in the inclined state of an imaging optical axis is recognized by rotating around the vertical line (a thirteenth aspect of the invention). The inclination of the imaging unit may be recognized by a difference in brightness in an imaging field of the imaging unit (a fourteenth aspect of the invention).

According to a fifteenth aspect of the invention, in the information output apparatus according to the sixth or seventh aspect of the invention, the medium may be a map, and the switching of the output information may be switching from the map to information, switching of layers of the map, continuous switching of enlargement or reduction of the map, continuous switching of a display position of the map to XY directions, and switching of a sight line. As such, since the map is selected as the medium, the image information (digital map) to be displayed on the display device as the output unit can be diversely changed.

The medium may be a map on which a dot pattern obtained by patterning three-dimensional map information by XYZ coordinates as coordinate information is superimposed and printed, and the output information may display a three-dimensional map image generated on the basis of the XYZ coordinates with respect to a fixation point viewed from a view point on a display device as the output unit by continuously switching the fixation point, an angle, or a viewing angle.

The switching of the output information may continuously switch an altitude of a viewpoint so as to display a corresponding three-dimensional map image on a display device as the output unit.

Accordingly, a three-dimensional image can be displayed by changing a Z coordinate of a view point while fixing the fixation point, or by changing the fixation point itself in a Z direction.

### Advantage of the Invention

According to the aspects of the invention, a plurality of information are defined to the dot pattern printed on the surface of the medium, such as a map, and the information is selectively output by an imaging operation of the imaging unit, thereby realizing a user-friendly medium and information output thereof.

### BRIEF DESCRIPTION OF THE DRAWINGS

FIG. 1 is a front view of a planar map of an embodiment of the invention.

FIG. 2 is an explanatory view showing a utilization state of a map.

FIG. 3 is a block diagram showing the system configuration of a computer and a scanner that are used in connection with a map.

FIG. 4 is an explanatory view showing an example of a dot pattern.

FIG. 5 is an enlarged view showing an example of an information dot of a dot pattern.

FIGS. 6A and 6B are explanatory views showing the arrangement of information dots.

FIG. 7 is a diagram showing an example of an information dot and bit display of data defined therein, and shows another embodiment.

FIGS. 8A to 8C show examples of an information dot and bit display of data defined therein, and specifically, FIG. 8A shows a case where two dots are disposed, FIG. 8B shows a case where four dots are disposed, and FIG. 8C shows a case where five dots are disposed.

FIGS. 9A to 9D show modifications of a dot pattern, and specifically, FIG. 9A is a schematic view showing a case where six information dots are disposed, FIG. 9B is a schematic view showing a case where nine information dots are disposed, FIG. 9C is a schematic view showing a case where 12 information dots are disposed, and FIG. 9D is a schematic view showing a case where 36 information dots are disposed.

FIGS. 10A and 10B are diagrams illustrating a format of a dot pattern in a planar map, and specifically, FIG. 10A is an explanatory view showing values defined in individual dots by a table, and FIG. 10B is an explanatory view showing the arrangement of individual dots.

FIGS. 11A and 11B are diagrams illustrating an operation that enlarges or reduces a map displayed on a display device (monitor) by clicking an icon portion, and specifically, FIG. 11A is a diagram showing a user's operation, and FIG. 11B is a diagram illustrating a screen on the display device (monitor) in FIG. 11A.

FIGS. 12A and 12B are diagrams illustrating an operation that scrolls a map on a display (monitor) by clicking an icon portion, and specifically, FIG. 12A is a diagram showing a user's operation, and FIG. 12B is a diagram illustrating a screen on the display (monitor) in FIG. 12A.

FIGS. 13A and 13B are diagrams illustrating an operation that scrolls a map on a display (monitor) by clicking a road in a map portion, and specifically, FIG. 13A is a diagram showing a user's operation, and FIG. 13B is a diagram illustrating a screen on the display (monitor) in FIG. 13A.

FIGS. 14A and 14B are diagrams illustrating an operation that scrolls a map on a display (monitor) by clicking a symbol in a map portion, and specifically, FIG. 14A is a diagram showing a user's operation, and FIG. 14B is a diagram illustrating a screen on the display (monitor) in FIG. 14A.

FIGS. 15A and 15B are diagrams illustrating an operation that displays a symbol on a display (monitor) by clicking an icon portion, and specifically, FIG. 15A is a diagram showing a user's operation, and FIG. 15B is a diagram illustrating a screen on the display (monitor) in FIG. 15A.

FIGS. 16A and 16B are diagrams illustrating an information mode, and specifically, FIG. 16A is a diagram showing a user's operation, and FIG. 16B is a diagram illustrating a screen on the display (monitor) in FIG. 16A.

FIGS. 17A to 17C are diagrams illustrating an operation that switches from a map mode to an information mode.

FIGS. 18A to 18C are diagrams illustrating an operation that scrolls a map on a display (monitor) according to an orientation of a scanner, and specifically, FIG. 18A is a diagram showing a user's operation, FIG. 18B is a diagram illustrating a state where the scanner is inclined, and FIG. 18C is a diagram illustrating a screen on the display (monitor) in FIG. 18B.

FIGS. 19A to 19C are diagrams illustrating an operation that scrolls a map on a display (monitor) according to an inclination of a scanner, and specifically, FIG. 19A is a diagram showing a user's operation, FIG. 19B is a diagram illustrating a state where the scanner is inclined, and FIG. 19C is a diagram illustrating a screen on the display (monitor) in FIG. 19B.

FIGS. 20A to 20C are diagrams illustrating the relationship between an inclination and an orientation of a scanner and a scroll direction.

FIGS. 21A and 21B are diagrams illustrating an operation that enlarges a map on a display (monitor) by rotating a scanner, and specifically, FIG. 21A is a diagram showing a user's operation, and FIG. 21B is a diagram illustrating a screen on the display (monitor) in FIG. 21A.

FIGS. 22A and 22B are diagrams illustrating an operation that reduces a map on a display (monitor) by rotating a scanner, and specifically, FIG. 22A is a diagram showing a user's operation, and FIG. 22B is a diagram illustrating a screen on the display (monitor) in FIG. 22A.

FIGS. 23A and 23B are diagrams illustrating a format of a dot pattern in a three-dimensional map according to another embodiment of the invention, and specifically, FIG. 23A is an explanatory view showing values defined in individual dots by a table, and FIG. 23B is an explanatory view showing the arrangement of individual dots.

FIGS. 24A to 24C are diagrams illustrating an operation that changes a view point by rotating a scanner in a three-dimensional map, and specifically, FIGS. 24A and 24B are diagram showing a user's operation, and FIG. 24C is a diagram illustrating a screen on a display (monitor) in FIGS. 24A and 24B.

FIG. 25 is a diagram illustrating an operation that tilts up or tilts down a view point and illustrates a user's operation.

FIGS. 26A to 26C are diagrams illustrating an operation that tilts up or tilts down a view point, and specifically, illustrates a screen displayed on a display (monitor) when each operation of FIG. 25 is performed.

FIGS. 27A and 27B are diagrams illustrating an operation that changes a view point left or right, and specifically, FIG. 27A is a diagram showing a user's operation, and FIG. 27B is a diagram illustrating a screen on a display (monitor) in FIG. 27A.

FIGS. 28A and 28B are diagrams illustrating an operation that changes a view point left or right, and specifically, illustrate a screen on a display (monitor) in FIGS. 27A and 27B.

FIGS. 29A and 29B are diagrams illustrating an operation that changes a mode of a screen on a display (monitor) by a grid pump operation, and specifically, FIG. 29A is a diagram showing a user's operation, and FIG. 29B is a diagram illustrating a screen on the display (monitor) in a normal mode.

FIGS. 30A and 30B are diagrams illustrating an operation that changes a mode of a screen on a display (monitor) by a grid pump operation, and specifically, FIG. 30A is a diagram illustrating a case where a display mode is changed to a telephoto mode on the display (monitor), and FIG. 30B is a diagram illustrating a case where a display mode is changed to a wide mode on the display (monitor).

FIGS. 31A to 31C are diagrams illustrating an operation that resets a view point to a normal mode by a grid tapping operation, and specifically, FIG. 31A is a diagram illustrating a user's operation, FIG. 31B is a diagram illustrating a screen on a display (monitor) before the operation, and FIG. 31C is a diagram illustrating a screen on the display (monitor) after the operation.

FIGS. 32A and 32B are explanatory views showing another embodiment of a scanner that is used to perform various operations on a map.

FIG. 33 is diagrams illustrating a method of measuring inclination direction and angle when various operations are performed according to an inclination of a scanner.

FIGS. 34A and 34B are diagrams illustrating a method of measuring inclination direction and angle when various operations are performed according to an inclination of a scanner.

FIG. 35 is a diagram illustrating a method of measuring an inclination direction when various operations are performed according to an inclination of a scanner.

FIG. 36 is a diagram illustrating a method of measuring an inclination direction using a Fourier function when various operations are performed according to an inclination of a scanner.

FIG. 37 is a diagram illustrating a method of measuring an inclination direction using an equation of n-th degree when various operations are performed according to an inclination of a scanner.

FIGS. 38A to 38C are diagrams illustrating a function of designating a range by a grid drag operation and displaying a symbol on a display (monitor).

FIGS. 39A and 39B are diagrams illustrating a function of displaying a cross-section on a display (monitor) by a grid drag operation.

### DESCRIPTION OF REFERENCE NUMERALS AND SIGNS

CPU: CENTRAL PROCESSING UNIT

MM: MAIN MEMORY

USB I/F: USB INTERFACE

HD: HARD DISK DEVICE

DISP: DISPLAY DEVICE (DISPLAY UNIT)

KBD: KEYBOARD

NW I/F: NETWORK INTERFACE

NW: NETWORK

### BEST MODE FOR CARRYING OUT THE INVENTION

### First Embodiment

### Planar Map

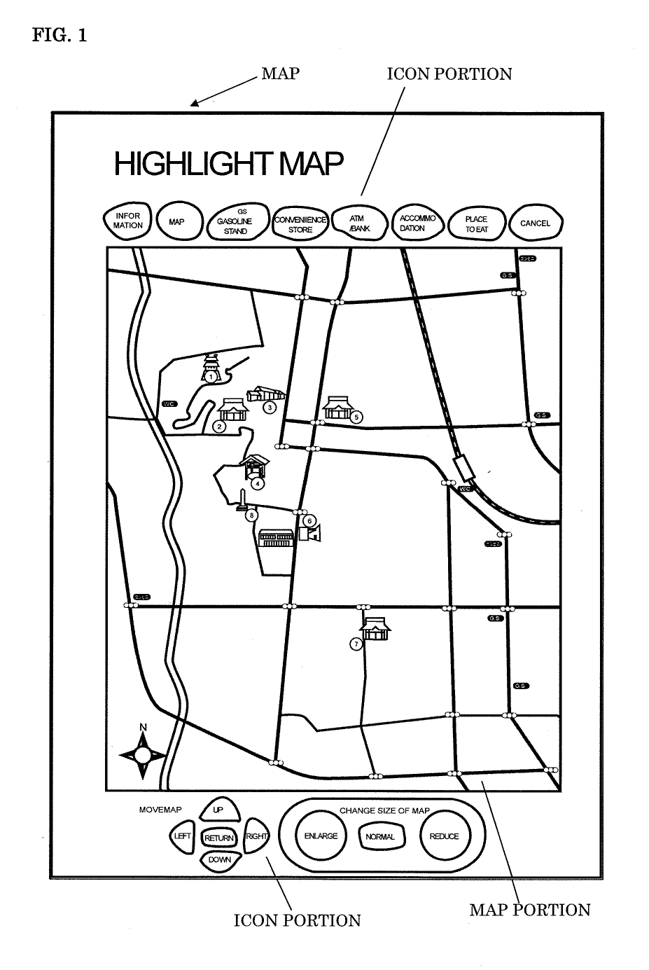

FIGS. 1 to 22B relates to a first embodiment of the invention.

In this embodiment, a map is used as a medium. If the map is captured by a pen-type scanner (imaging unit), a map or information corresponding to the captured content is displayed on a display device (monitor) as an output unit. On the display device, an electronic map installed in a personal computer, or corresponding characters, figures, sound, and motion pictures are displayed.

FIG. 1 is a diagram showing a surface printing state of a map (medium) that is used herein.

The map used herein has an icon portion where an icon is printed that instructs an operation for performing various kinds of display on the display device, and a map portion where roads, railroad lines, and tourist facilities are printed.

In each icon region of the icon portion, a dot pattern indicating a code corresponding to an operation instruction is printed. A dot pattern printed therein will be described below. The icon portion is printed in upper and lower sides of the map. On the upper side, icons of ‘information’, ‘map’, ‘GS gasoline stand’, ‘convenience store’, ‘ATM bank’, ‘accommodation’, ‘places to eat’, and ‘cancel’ are provided.

On the lower side, icons of ‘up’, ‘right’, ‘down’, ‘left’, and ‘return’ for moving the electronic map, and icons of ‘enlarge’, ‘normal’, and ‘reduce’ for changing the size of the electronic map are printed.

In the map portion, symbols indicating roads, railroad lines, and tourist facilities are printed. In regions of the map portion, dot patterns indicating XY coordinates corresponding to positions of the roads or the railroad lines are printed. Further, in the symbols, dot patterns obtained by coding facility information or the like are superimposed and printed, in addition to the XY coordinates corresponding to the positions of the facilities or the like.

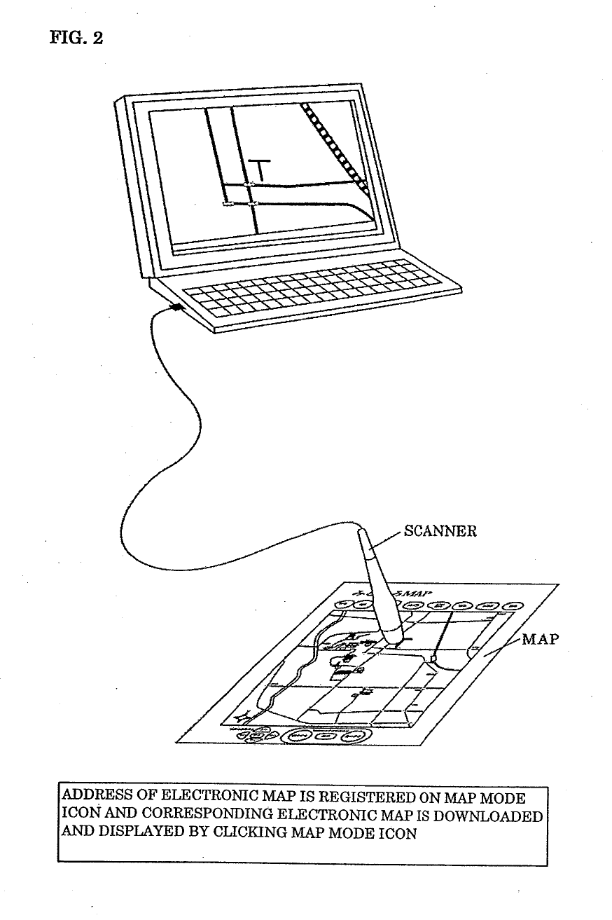

FIG. 2 is an explanatory view showing a utilization state of the map.

As shown in the drawing, in the invention, the map (medium) is used in connection with an electronic apparatus, such as a personal computer, and a pen-type scanner (imaging unit). That is, the pen-type scanner is connected to the computer by a USB cable or the like. A user clicks (captures) an arbitrary position or symbols on the map portion, or various icons printed in the icon portion using the scanner.

An address of the electronic map is registered in a map mode icon. If the user clicks the map mode icon, the electronic map registered in a hard disk device of the personal computer is read and then is output and displayed on a display.

Moreover, in FIG. 2, the scanner is connected to the computer, but the invention is not limited thereto. For example, the scanner may be used in connection with other communication apparatuses, such as a cellular phone, a PDA (Personal Digital Assistant), and the like.

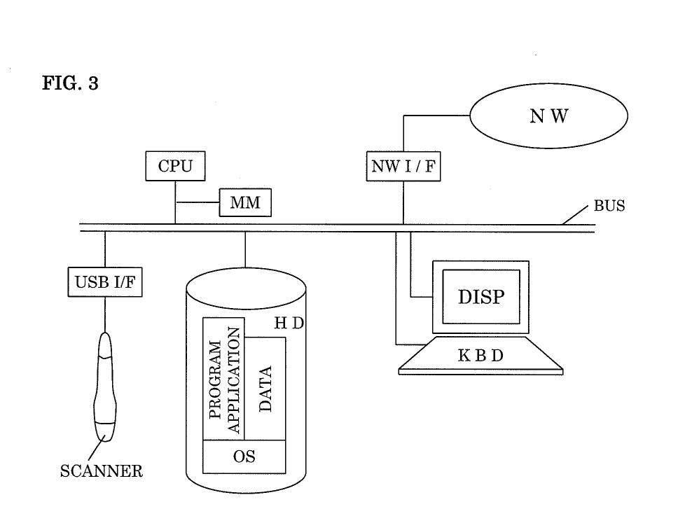

FIG. 3 is a hardware block diagram showing the configuration of the computer and the scanner.

As shown in FIG. 3, the personal computer has a central processing unit (CPU), a main memory (MM), and a hard disk device (HD), a display device (DISP) as an output unit, and a keyboard (KBD) as an input unit that are connected to the central processing unit by a bus.

Then, the scanner as an imaging unit is connected through a USB interface (USB I/F).

Though not shown, in addition to the display device (DISP), a printer, a speaker, and the like are connected as an output unit.

The bus (BUS) is connected to a general-use network (NW), such as Internet or the like, through a network interface (NW I/F), such that electronic map data, character information, image information, sound information, motion picture information, programs, and the like can be downloaded from a server (not shown).

In the hard disk (HD), an operating system (OS), application programs, such as an analysis program of a dot pattern used in this embodiment or the like, and data, such as electronic map data, character information, image information, sound information, motion picture information, or various tables, are registered.

The central processing unit (CPU) sequentially reads the application programs in the hard disk through the bus (BUS) and the main memory (MM) and executes them. Further, the central processing unit (CPU) reads out data and outputs and displays the data on the display device (DISP). As such, the functions to be described in this embodiment are implemented.

The scanner has an optical imaging element, such as an infrared ray irradiation unit (red LED) and an IR filter, a CMOS sensor, a CCD sensor, or the like, although not shown in the drawing. The scanner has a function of imaging reflected light of irradiation light irradiated on a surface of the medium. Here, the dot patterns on the surface of the medium are printed with carbon ink, and portions other than the dot patterns are printed with no-carbon ink.

Carbon ink has a light absorption characteristic, and thus only dot portions in the captured image by the optical imaging element are imaged black.

The captured image of the dot pattern read in such a manner is analyzed by a central processing unit (CPU) in the scanner, then is converted into a coordinate value or a code value, and subsequently is transmitted to the personal computer through a USB cable.

The central processing unit (CPU) of the personal computer refers to a table indicating the received coordinate value or code value and causes the display device (DISP) or the speaker (not shown) to output corresponding electronic map data, character information, image information, sound information, or motion picture information.

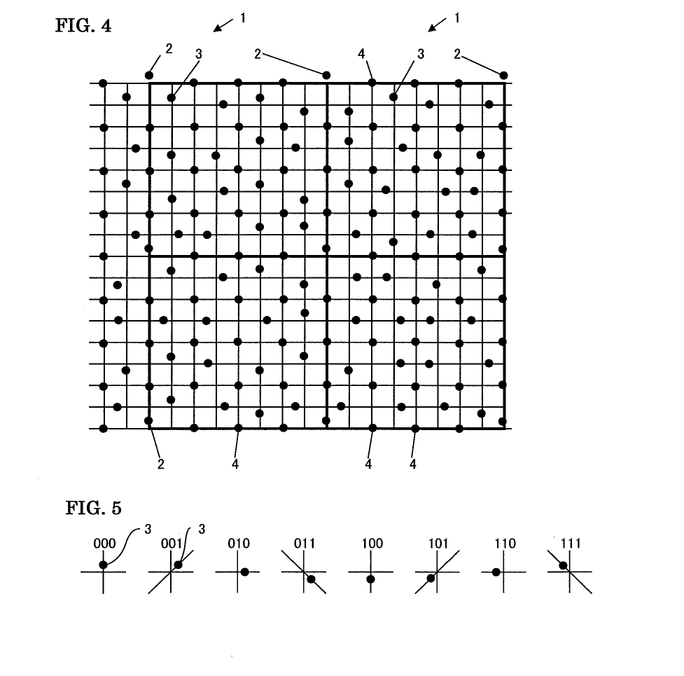

Next, the dot pattern used herein will be described with reference to FIGS. 4 to 9D.

FIG. 4 is an explanatory view showing GRID1 as an example of a dot pattern of the invention.

Moreover, in the drawings, for convenience of explanation, vertical and horizontal lattice lines are shown, but do not exist on a printing surface. When the scanner as the imaging unit has an infrared ray irradiation unit, key dots 2, information dots 3, reference lattice point dots 4 and the like constituting the dot pattern 1 are preferably printed with carbon ink that absorbs infrared rays.

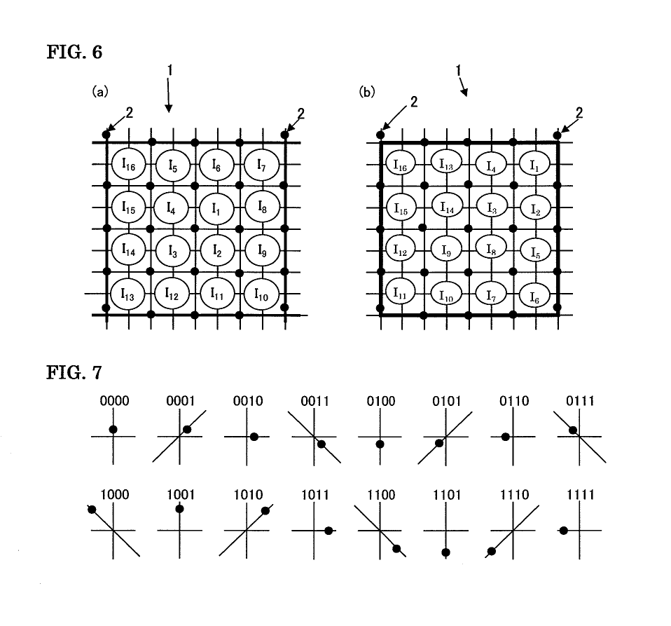

FIG. 5 is an enlarged view showing an example of the information dots of the dot pattern and bit display of data defined therein. FIGS. 6A and 6B are explanatory views showing the information dots disposed around the key dot.

An information input/output method using the dot pattern of the invention includes generation of the dot pattern 1, recognition of the dot pattern 1, and output of information and programs from the dot pattern 1. That is, in order to read the dot pattern 1 as image data by a camera, first, the reference lattice point dots 4 are extracted, then the key dots 2 are extracted on the basis of the fact that dots do not hit at positions where the reference lattice point dots 4 are originally disposed, and subsequently the information dots 3 are extracted. As such, through digitalization, the information regions are extracted and then the information is digitalized. On the basis of the digitalized information, the information and programs are output from the dot pattern 1. For example, the information, such as sound and the like, or programs are output from the dot pattern 1 to an information output apparatus, a personal computer, a PDA, or a cellular phone.

In the invention, upon generation of the dot pattern 1, fine dots for recognition of information, such as sound, that is, the key dots 2, the information dots 3, and the reference lattice point dots 4 are arranged according to predetermined rules by a dot code generation algorithm. As shown in FIG. 4, in each block of the dot pattern 1 representing information, 5×5 reference lattice point dots 4 are disposed on the basis of the key dots 2, and the information dot 3 is disposed in the vicinity of a virtual lattice point 5 surrounded by four reference lattice points 4. In the block, arbitrary digitalized information is defined. Moreover, in the example of FIG. 4, four blocks (in a bold-line frame) of the dot pattern 1 are arranged in parallel. Of course, the dot pattern 1 is not limited to four blocks.

One corresponding information and program may be output to one block or may be output to a plurality of blocks.

When the dot pattern 1 is taken as image data by a camera, imaging from distortion or slant of a lens of the camera, expansion and contraction of the paper, curvature of the surface of the medium, and distortion upon printing can be corrected using the reference lattice point dots 4. Specifically, the correction function (Xn, Yn)=f (Xn′, Yn′) for converting the distorted four reference lattice point dots 4 into the original rectangular shape is obtained, and the information dots 3 are corrected by the same function so as to calculate a vector of the correct information dots 3.

If the reference lattice point dots 4 are disposed in the dot pattern 1, as for image data obtained by taking the dot pattern 1 using the camera, the distortion due to the camera is corrected. Accordingly, even when the image data of the dot pattern 1 is taken by a popular camera including a lens having high distortion, the image data obtained by taking the dot pattern 1 using the camera can be accurately recognized. Further, even though the image data is taken in a state where the camera is inclined with the respect to the surface of the dot pattern 1, the dot pattern 1 can be accurately recognized.

As shown in FIG. 4, the key dots 2 are dots that are formed by disposing the four reference lattice point dots 4 at four corners of the block to be shifted in a predetermined direction. The key dots 2 are representative points of the dot pattern 1 for one block representing the information dots 3. For example, the reference lattice point dots 4 at the four corners of the block of the dot pattern 1 are shifted by 0.2 mm upward. When the information dots 3 represent X and Y coordinates, the positions where the key dots 2 are shifted by 0.2 mm downward become coordinate points. However, this numerical value is not limited thereto, but may vary according to the size of the block of the dot pattern 1.

The information dots 3 are dots for the recognition of information. The information dots 3 are arranged around the key dot 2 as a representative point, and simultaneously are disposed at end points expressed by a vector with the virtual lattice point 5, that is, the center surrounded by the four reference lattice point dots 4, as a start point. For example, the information dots 3 are respectively surrounded by the reference lattice point dots 4 and, as shown in FIG. 5, the dots spaced from the virtual lattice point 5 by 0.2 mm have direction and length expressed by the vector. Then, these dots are rotated by 45 degrees in a clockwise direction and then disposed in eight directions. These dots represent three bits. Therefore, three bits×16=48 bits can be expressed by the dot pattern 1 of one block.

Moreover, in the example shown in the drawing, the three bits are expressed by disposing the dots in the eight directions, but the invention is not limited thereto. For example, four bits can be expressed by disposing the dots in 16 directions. Of course, other changes can be made.

The diameter of the key dot 2, the information dot 3, or the reference lattice point dot 4 is preferably about 0.1 mm in consideration of visual quality, printing accuracy to paper quality, resolution of the camera, and optimum digitalization.

Further, a gap between the reference lattice point dots 4 is about 1 mm in the horizontal/vertical direction in consideration of a required information amount for an imaging area and misrecognition of various dots 2, 3, and 4. The shift amount of the key dot 2 is preferably about 20% of the lattice gap in consideration of misrecognition of the reference lattice point dot 4 and the information dot 3.

A gap between the information dot 3 and the virtual lattice point surrounded by the four reference lattice point dots 4 is preferably a gap of 15 to 30% of a distance between adjacent virtual lattice points 5. If a distance between the information dot 3 and the virtual lattice point 5 is shorter than the gap, the dots are likely to be recognized as a large lump and are difficult to be considered as the dot pattern 1. In contrast, if the distance between the information dot 3 and the virtual lattice point 5 is longer than the gap, it is difficult to recognize whether or not the information dot 3 keeps vector directionality around an adjacent virtual lattice point 5.

For example, as shown in FIG. 6A, the information dots 3 of I₁ to I₁₆ are arranged from the center of the block in a clockwise direction to have a lattice gap of 1 mm and represents 3 bits×16=48 bits by 4 mm×4 mm.

Moreover, subblocks that have individual information contents having no effect on other information content may be provided in the block. FIG. 6B shows these subblocks. In the subblocks [I₁, I₂, I₃, I₄], [I₅, I₆, I₇, I₈], [I₉, I₁₀, I₁₁, I₁₂], and [I₁₃, I₁₄, I₁₅, I₁₆], each having four information dots 3, independent data (3 bits×4=12 bits) are expanded in the information dots 3. As such, if the subblocks are provided, error check can be easily performed in subblocks.

Preferably, vector directions (rotation direction) of the information dots 3 are uniformly determined for every 30 to 90 degrees.

FIG. 7 is a diagram showing an example of the information dot 3 and bit display of data defined therein, and shows another embodiment.

For the information dots 3, two long and short dots from the virtual lattice point 5 surrounded by the reference lattice point dots 4 are used. If the vector directions are 8 directions, 4 bits can be represented. At this time, the longer dot is preferably about 25 to 30% of the distance between adjacent virtual lattice points 5 and the shorter dot is preferably about 15 to 20% thereof. However, an inter-center gap between the long and short information dots 3 is preferably longer than the diameter of the dot.

The number of information dots 3 surrounded by the four reference lattice point dots 4 is preferably one in consideration of visual quality. However, when a desired information amount is large regardless of visual quality, one dot is assigned for one vector, and a plurality of information dots 3 are represented, thereby having a large amount of information. For example, in case of an eight-directional vector of a concentric circle, the information dots 3 surrounded by the four reference lattice point dots 4 can represent information of 2⁸. The 16 information dots of one block become 2¹²⁸.

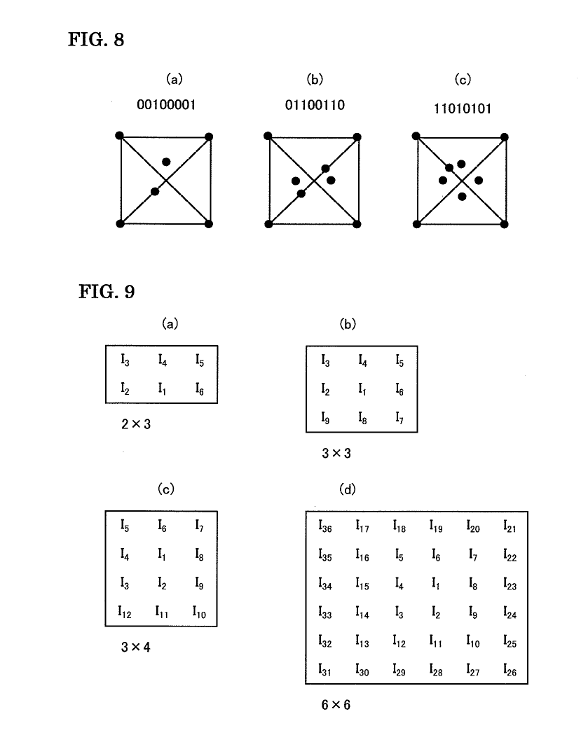

FIGS. 8A to 8C show examples of the information dot and bit display of data defined therein. Specifically, FIG. 8A shows a case where two dots are disposed, FIG. 8B shows a case where four dots are disposed, and FIG. 8C shows a case where five dots art disposed.

FIGS. 9A to 9D show modifications of the dot pattern. Specifically, FIG. 9A is a schematic view showing a case where six information dots are disposed, FIG. 9B is a schematic view showing a case where nine information dots are disposed, FIG. 9C is a schematic view showing a case where 12 information dots are disposed, and FIG. 9D is a schematic view showing a case where 36 information dots are disposed.

In the dot patterns 1 shown in FIGS. 4 and FIGS. 6A and 6B, 16 (4×4) information dots 3 are disposed in one block. However, the invention is not limited to the 16 information dots 3, but various changes can be made. For example, according to the size of a required information amount or resolution of the camera, 6 (2×3) information dots 3 may be disposed in one block (a), 9 (3×3) information dots 3 may be disposed in one block (b), 12 (3×4) information dots 3 may be disposed in one block (c), or 36 information dots 3 may be disposed in one block (d).

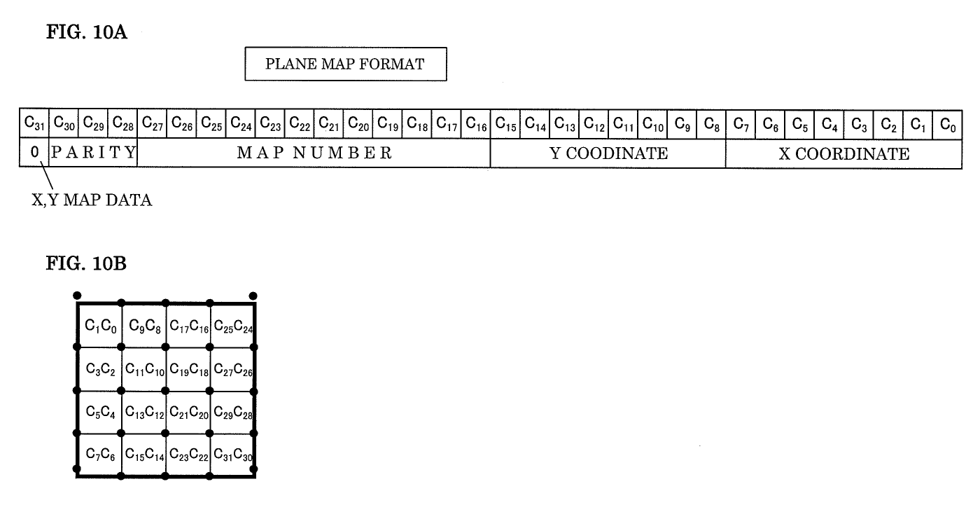

Next, FIGS. 10A and 10B show the relationship between the dot pattern printed on the surface of the map, and the code value and the XY coordinate value.

FIG. 10A shows values, which are defined by 32 bits of C₀ to C₃₁ of the dot pattern, by a table. C₀ to C₇ represent X coordinates, C₈ to C₁₅ represent Y coordinates, C₁₆ to C₂₇ represent map numbers, C₂₈ to C₃₀ represent parity bits, and C₃₁ represents XY map data.

Moreover, C₁₆ to C₂₇ are not limited to map numbers, but may represent other codes (code value).

These values are disposed in lattice regions shown in FIG. 10B.

As such, in this dot pattern, the X coordinates, the Y coordinates, and corresponding code information (code values) can be registered in 4×4 lattice regions. Accordingly, specific code information can be given to a region of a symbol on the map, together with the XY coordinates. With the formatting of such a dot pattern, the information based on the XY coordinates, and texts, images, motion pictures, and sound information corresponding to a symbol icon of a building or the like can be associated and output.

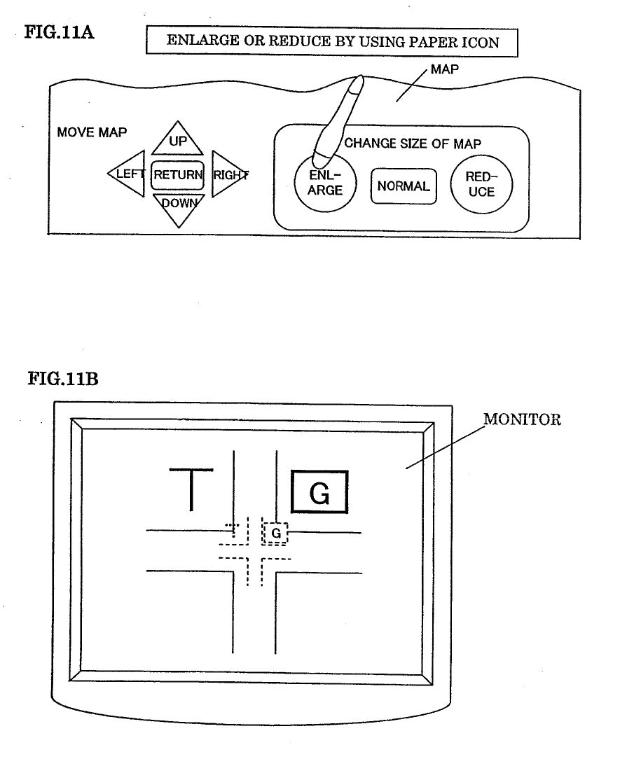

FIGS. 11A and 11B are diagrams illustrating an operation that enlarges or reduces an electronic map by clicking an icon displayed on the lower side of the icon portion.

FIG. 11A is a diagram showing an operation that is performed on the map by a user, and FIG. 11B is a diagram showing a video that is displayed on the display device (monitor) when the corresponding operation is performed. As shown in FIG. 11A, if the user clicks the symbol ‘enlarge’ located on the lower side of the icon portion using the scanner, an imaging element captures the dot pattern printed on the symbol. Then, the captured image is analyzed by the internal central processing unit (CPU) of the scanner, then is converted into a dot code (coordinate value or code value), and subsequently is transmitted to the personal computer.

The central processing unit (CPU) of the personal computer refers to a table in the hard disk device (HD) on the basis of the dot code, reads image data (in this example, enlarged data of the electronic map) stored corresponding to the dot code, and displays that on the display device (monitor).

The central processing unit (CPU) may perform a display control of the display device (DISP) on the basis of the dot code, and may directly enlarge the image data of the map displayed on the display (monitor).

In such a manner, as shown in FIG. 8B, the magnification of the electronic map on the display device (monitor) is enlarged. Similarly, if the symbol ‘reduce’ is clicked, the magnification of the electronic map is reduced. If the symbol ‘normal’ is clicked, the normal magnification returns.

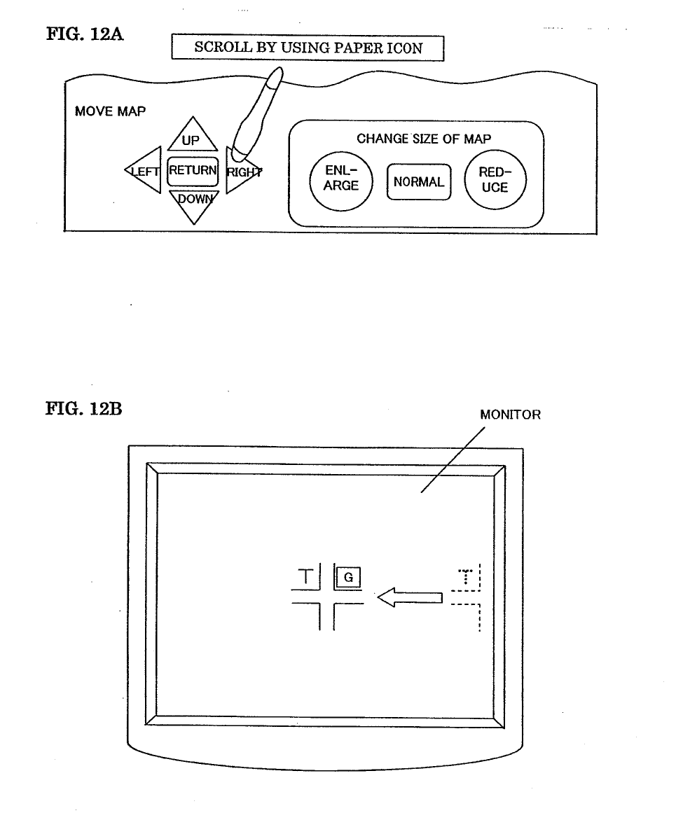

FIGS. 12A and 12B are diagrams illustrating an operation that moves a map to be displayed on the display device (monitor) by clicking an icon displayed on the lower side of the icon portion.

In FIG. 12A, if the icon ‘right’ is clicked (captured by the scanner), the central processing unit (CPU) of the scanner analyzes the dot pattern of the icon by an analysis program, converts the dot pattern into the dot code (coordinate value or code value), and transmits the converted dot code to the personal computer.

The central processing unit (CPU) of the personal computer that receives the dot code refers to the table in the hard disk device (HD) on the basis of the dot code, reads out the image data (in this example, map data on the right side than the coordinate position of the electronic map) stored corresponding to the dot code, and displays the image data on the display device (monitor).

The central processing unit (CPU) may perform a display control of the display device (DISP) on the basis of the dot code, and may directly move and draw the image data of the map displayed on the display (monitor).

In the above-described embodiment, an example where the image data displayed on the display device (DISP) moves in the left direction on the screen by the icon ‘right’ has been described, but the image data may move in the right direction.

Similarly, if the user clicks ‘ left’, the image data of the map is scrolled leftward (or rightward). If ‘up’ is clicked, the image data of the map is scrolled upward (or downward), and, if ‘down’ is clicked, it is scrolled downward (or upward). In addition, if ‘return’ is clicked, the image data of the map returns to the state before the scroll.

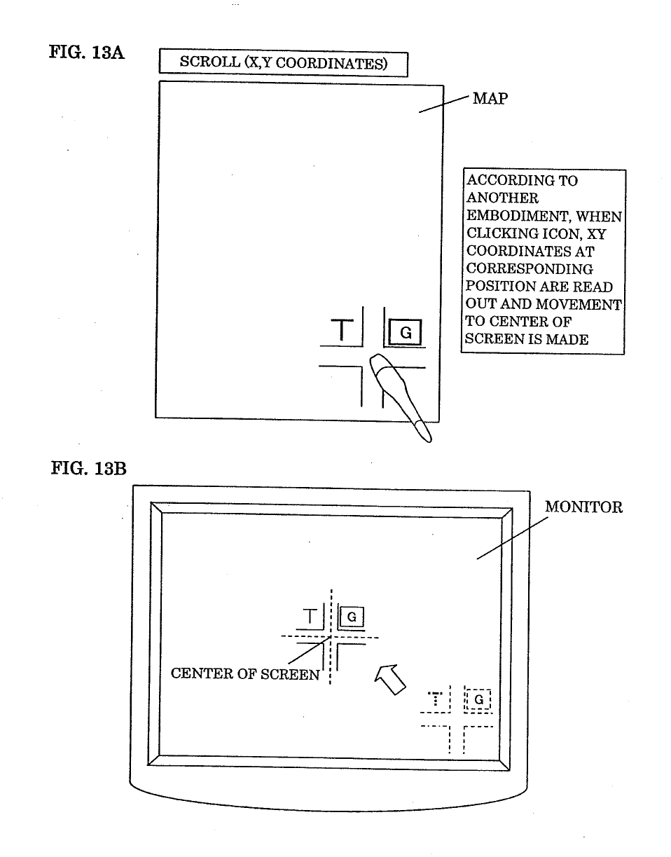

FIGS. 13A and 13B are diagrams illustrating an operation that scrolls the electronic map by clicking the map by the user.

FIGS. 13A and 13B are diagrams illustrating a case where the user clicks an arbitrary position, such as a road, a river, or the like on the map. Specifically, FIG. 13A is a diagram showing an operation that is performed on the map by the user, and FIG. 13B is a diagram showing a video that is displayed on the display device (monitor) when the corresponding operation is performed. For example, as shown in FIG. 13A, if the user clicks a cross of the road using the scanner, the central processing unit (CPU) of the scanner analyzes the dot pattern by an analysis software program. The dot code is transmitted to the central processing unit (CPU) of the computer. The computer reads only a code representing the XY coordinates of that position in the dot code. In such a manner, as shown in FIG. 13B, the image data of the map is scrolled such that the cross is located at the center of the display.

According to the invention, a click point is not limited to the road or river, but may be a symbol on the map, such as a gas station or the like. If the user clicks the symbol, according to the above-described method, the code representing the XY coordinates of the symbol is read, and the image data of the map is scrolled such that the symbol is located at the center of the display.

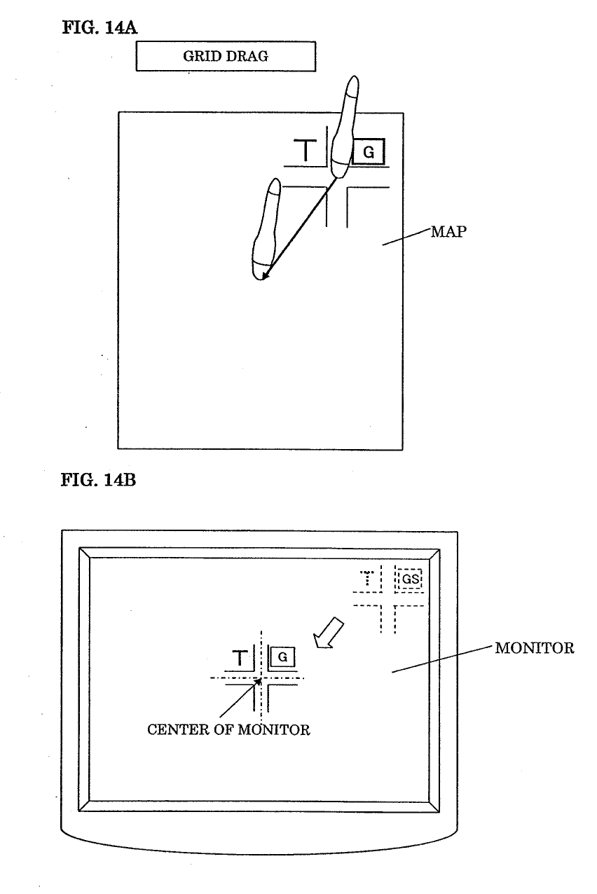

FIGS. 14A and 14B are diagrams illustrating an operation that scrolls the electronic map by a grid drag operation.

FIG. 14A is a diagram showing an operation that is performed on the map by the user, and FIG. 14B is a diagram showing a video that is displayed on the display when the corresponding operation is performed. Here, the grid drag operation refers to move the scanner in a state where the scanner is in contact with the map portion. In this example, the user initially clicks the center of the cross, and moves the scanner to the center of the map portion so as not to be separated from the map portion. With this operation, as shown in FIG. 14B, the screen is scrolled such that the center of the cross is located at the center of the display.

With this operation, first, the scanner reads the coordinate value of the cross, and then the coordinate value changes as the scanner moves.

The coordinate values changed in such a manner are sequentially transmitted to the personal computer. The central processing unit (CPU) of the personal computer moves (scrolls) the electronic map displayed on the display device (monitor) on the basis of the change of the coordinate value. As a result, according to the invention, the electronic map is scrolled such that the clicked point is displayed at the center of the display.

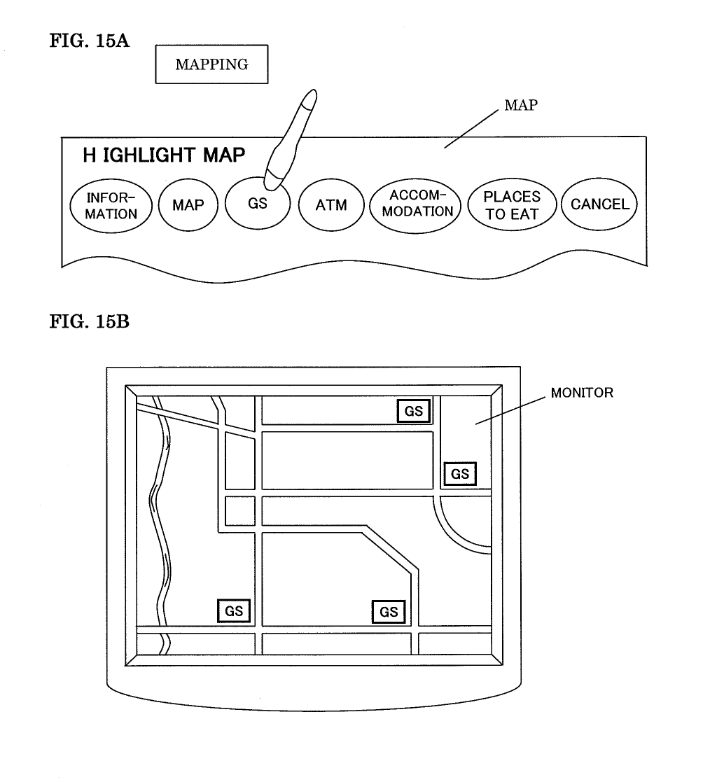

FIGS. 15A and 15B are diagrams illustrating a search function of facilities or the like.

FIG. 15A is a diagram showing an operation that is performed on the map by the user, and FIG. 15B is a diagram showing a video that is displayed on the display device (monitor) when the corresponding operation is performed.

If the user clicks any one icon of ‘GS’, ‘ATM’, ‘ accommodation’, and ‘places to eat’ printed on the upper side of the map, an icon symbol indicating the facility corresponding to the symbol is displayed on the electronic map. For example, as shown in FIG. 15A, if the user clicks the icon ‘GS’, as shown in FIG. 15B, a symbol ‘GS’ indicating a gas station is displayed at a position on the electronic map where the gas station exists. Similarly, if the user clicks the icon ‘ATM’, an icon indicating an ATM of a bank or the like is displayed. Further, if the user clicks the icon ‘accommodation’, a symbol indicating a lodging facility, such as a hotel or an inn, is displayed, and, if the user clicks the symbol ‘places to eat’, a symbol indicating a restaurant is displayed. Accordingly, the user can easily know where a target facility is located.

Here, in the icons ‘GS’, ‘ATM’, ‘accommodation’, and ‘places to eat’, a code value is printed as a dot pattern for every predetermined number of icons. Then, if the imaging element of the scanner reads the dot pattern as the captured image, the central processing unit (CPU) of the scanner converts the dot pattern into the code value on the basis of the analysis program of a ROM, and transmits the code value to the personal computer.

The central processing unit (CPU) of the personal computer searches the table on the basis of the code value, and maps and displays a symbol image corresponding to the code value on an electronic map image displayed on the display (monitor).

In a state where the symbol is displayed on the electronic map, if the user clicks the icon corresponding to the symbol, the symbol on the electronic map is removed.

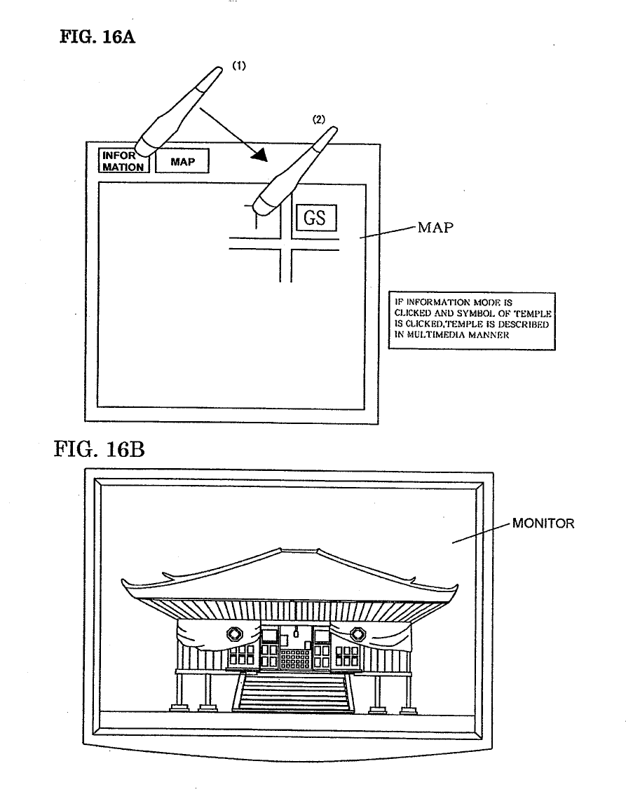

FIGS. 16A and 16B are diagrams illustrating an information mode.

The information mode refers to a state where information (characters, images, sound, motion pictures, and the like) corresponding to the symbol on the map is explained.

In this embodiment, in an initial setting, a map mode is set. In order to switch from the map mode to the information mode, as shown in FIG. 16A, the user first clicks the icon ‘information’ on the upper side of the icon portion. Accordingly, a switching processing from the map mode to the information mode is performed.

Specifically, in the icon ‘information’, a predetermined code value is printed as a dot pattern. Then, if the imaging element of the scanner reads the dot pattern as image data, the central processing unit (CPU) of the scanner converts the dot pattern into the code value by the analysis program of the ROM, ad transmits the code value to the personal computer.

The central processing unit (CPU) of the personal computer that receives the code value switches a display mode of the display (monitor) to the information mode.

Next, the user clicks a symbol indicating a facility whose information is desired. For example, as shown in FIG. 16A, the user clicks a symbol of a temple. Then, a code value indicating the temple is transmitted to the personal computer. The central processing unit (CPU) of the personal computer that receives the code value of the temple searches the table on the basis of the code value and outputs information (characters, images, sound, motion pictures, and the like) corresponding to the code value from the display (monitor). Here, the video of the temple is displayed on the display, and sound for explaining the temple is output from the speaker.

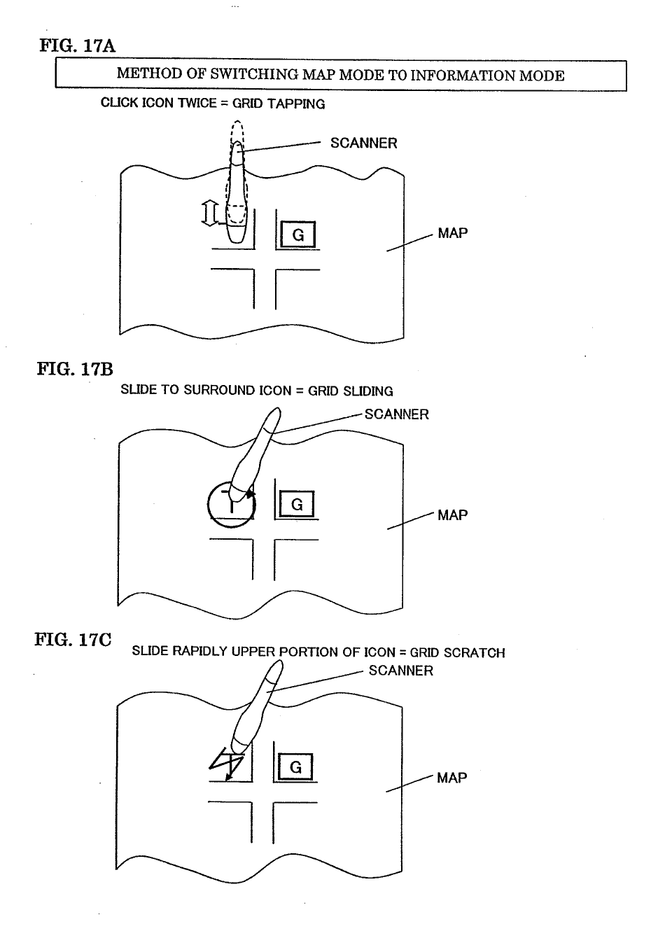

FIGS. 17A to 17C are diagrams illustrating a method of switching from the map mode to the information mode.

As shown in FIGS. 16A and 16B, on the upper side of the icon portion, two icons of ‘information’ and ‘map’ are printed. However, mode switching can be performed by an operation of the scanner, instead of clicking these icons.

FIG. 17A shows a case where switching is performed by a grid tapping operation. The grid tapping operation refers to an operation that stands the scanner in a direction perpendicular to the map and hits against the map while moving the scanner up and down. For example, if the user performs the grid tapping operation on the symbol of the temple, switching from the map mode to the information mode is performed, and the video of the temple is displayed on the display (monitor).

Specifically, the central processing unit (CPU) of the personal computer recognizes that the grip tapping operation is performed when the substantially same XY coordinate information or code information are read in a predetermined time multiple times.

FIG. 17B shows a case where switching is performed by a grid sliding operation. The grid sliding operation refers to an operation that circularly slides the scanner on the map. The user performs the grid sliding operation so as to surround the symbol. Accordingly, switching from the map mode to the information mode is performed, and the video of the temple is displayed on the display (monitor).

Specifically, the central processing unit (CPU) of the personal computer recognizes that the grip sliding operation is performed when XY coordinate information read in a predetermined time by the circular grid sliding operation of the imaging unit on the surface of the medium is recognized as a substantially circular trace.

FIG. 17C shows a case where switching is performed by a grid scratch operation. The grid scratch operation refers to an operation that moves the scanner on the map several times as a scratch. The user performs the grid scratch operation on the symbol. Accordingly, switching from the map mode to the information mode is performed, and the video of the temple is displayed on the display (monitor).

Specifically, the central processing unit (CPU) of the personal computer recognizes that the grip scratch operation is performed when a trace of XY coordinates read in a predetermined time is recognized as a repetition of a short linear trace (scratch).

The operation of the scanner for switching from the map mode to the information mode is not limited to the above-described embodiment. With other operations than the above-described operations by the user, switching to the information mode may be performed.

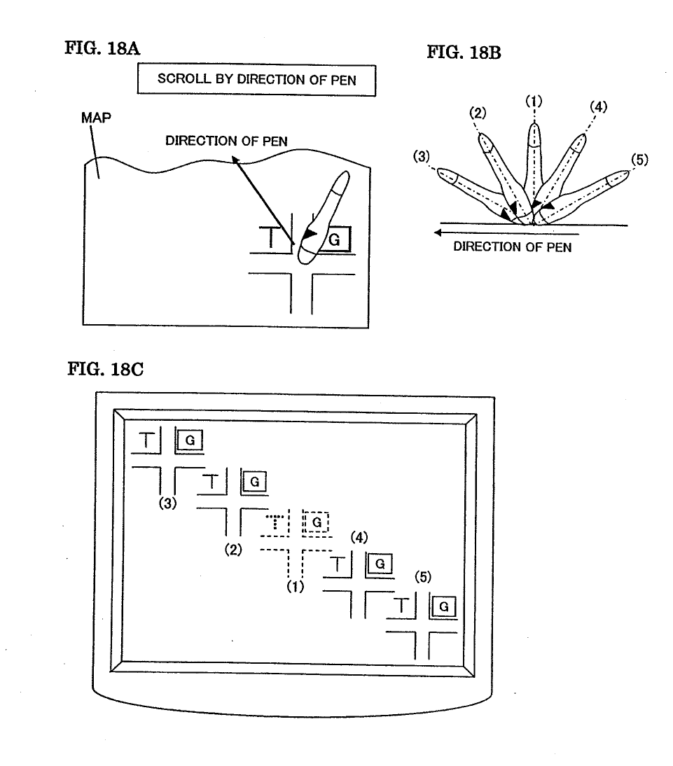

FIGS. 18A to 18C are diagrams illustrating an operation that scrolls the electronic map according to an orientation of the scanner (grid tilt operation). Specifically, FIG. 18A is a diagram illustrating an operation of the user, FIG. 18B is a diagram illustrating a case where the inclination of the scanner changes with respect to the vertical direction, and FIG. 18C is a diagram illustrating a state where the electronic map is being scrolled on the display (monitor).

The orientation of the scanner refers to an orientation in which a frame buffer becomes upward upon imaging. As shown in FIG. 18A, the user sets the orientation of the scanner in a direction to be scrolled and clicks. Then, a position where the user clicks is scrolled in a direction indicated by the orientation of the scanner.

In this case, a scroll distance of the electronic map is determined by the inclination of the scanner with respect to the vertical line of the map and an angle between the scanner and the map. In FIG. 18B, (1) shows a state where the scanner stands upright before inclined, (2) shows a state where the scanner is inclined forward, (3) shows a state where the scanner is further inclined forward, (4) shows a state where the scanner is inclined backward, and (5) shows a state where the scanner is further inclined backward. As such, the operation that inclines the scanner forward or backward is referred to as grid tilt. For each case, FIG. 18C illustrates how the electronic map is scrolled on the display (monitor). It is assumed that a point on the map portion clicked by the user is located at the center of the screen before the scanner is inclined. Then, when the scanner is inclined forward, the electronic map moves in parallel with the same direction as a direction indicated by the orientation of the scanner. Further, if the scanner is deeply inclined, a moving speed and a moving distance increase. Meanwhile, when the scanner is inclined backward, the electronic map moves in a direction opposite to the direction indicated by the orientation of the scanner by 180 degrees. Like a case where the scanner is inclined forward, as the scanner is deeply inclined, the moving speed and the moving distance increase.

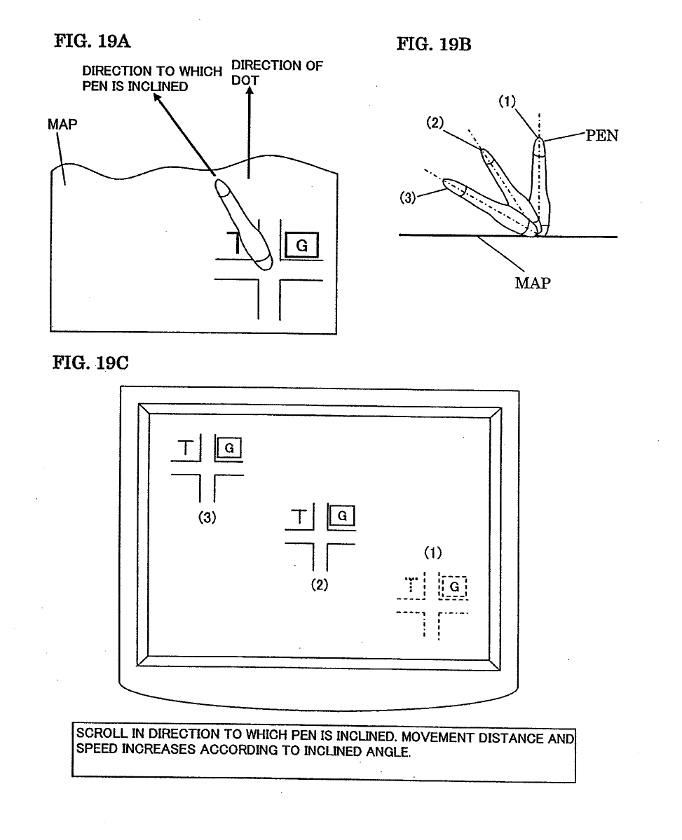

FIGS. 19A to 19C are diagrams illustrating an operation that scrolls the map displayed on the display device (monitor) according to the inclination of the scanner with respect to the orientation of the dot pattern. Specifically, FIG. 19A is a diagram illustrating the operation of the user, FIG. 19B is a diagram illustrating a case where the inclination of the scanner with respect to the vertical direction changes, and FIG. 19C is a diagram illustrating a state where the electronic map is scrolled on the display (monitor).

The inclination of the scanner refers to an angle between the orientation of the dot pattern and a scanner main body. The electronic map is scrolled in a direction in which the scanner is inclined.

A scroll distance is determined by a depth at which the scanner is inclined. In FIG. 19B, (1) shows a state where a pen stands upright before inclined, (2) shows a state where the pen is inclined forward, and (3) shows a state where the pen is further inclined forward. For each case, FIG. 19C illustrates how the electronic map is scrolled on the display (monitor). It is assumed that a point on the map clicked by the user is located on a lower right side of the screen before the scanner is inclined. When the scanner is inclined forward, the electronic map moves in parallel with the same direction as the direction indicated by the orientation of the scanner. Further, as the scanner is deeply inclined, the moving speed and the moving distance increase.

The direction in which the scanner is inclined and the scroll direction of the electronic map on the display may be reversed.

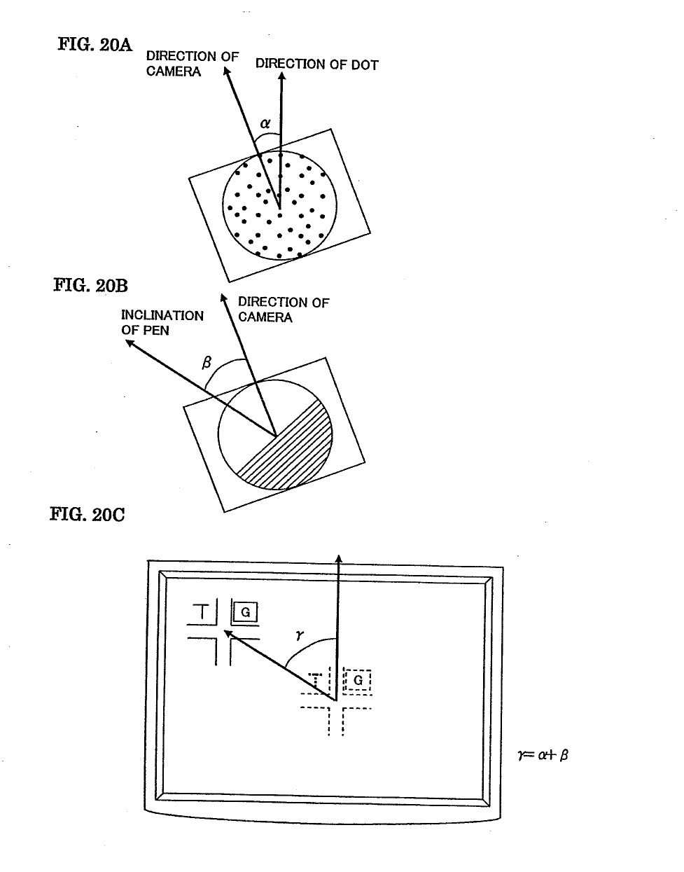

FIGS. 20A to 20C are diagrams illustrating the relationship between the inclination of the scanner and an angle at which the map on the display (monitor) is scrolled.

The dot pattern on the map is superimposed and printed in the same direction as a vertical direction of the paper. As shown in FIG. 20A, it is assumed that an angle between the orientation of the dot pattern and the orientation of the scanner is α. Further, as shown in FIG. 20B, it is assumed that, when the user inclines the scanner, an angle between the inclination of the scanner and the orientation of the scanner is β. In this case, the electronic map moves in a direction of an angle γ between the inclination of the scanner and the orientation of the dot. That is, the angle γ becomes as follows.

γ=α+β.

The inclination of the scanner can be recognized by a difference in brightness in an imaging field, and this will be described below.

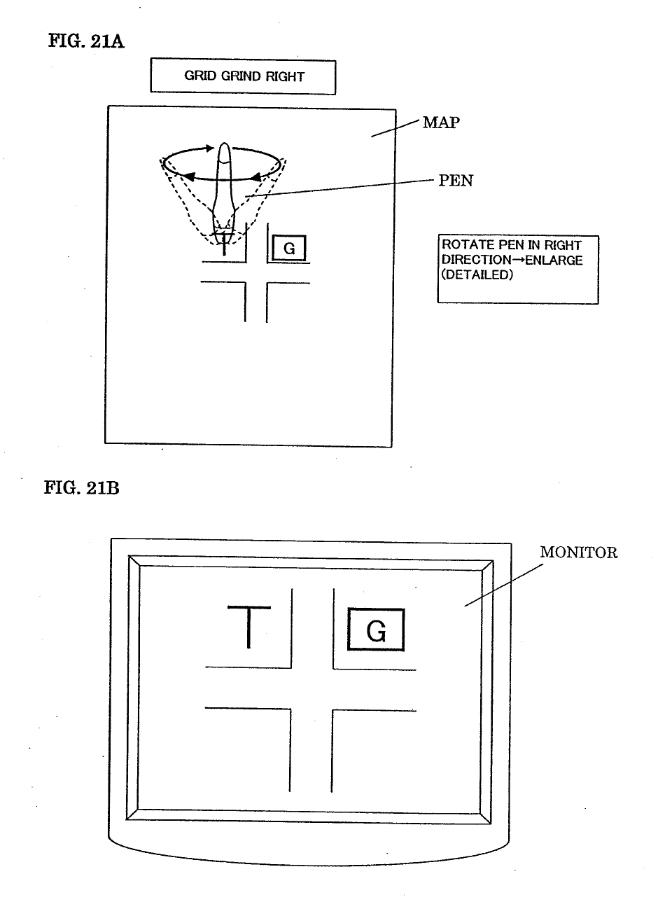

FIGS. 21A and 21B are diagrams illustrating an operation of the scanner for enlarging the screen displayed on the display (monitor) by a grid grind operation.

The grid grind operation refers to an operation that rotates the scanner. FIG. 21A is a diagram showing an operation that is performed on the map by the user, and FIG. 21B is a diagram showing a video that is displayed on the display (monitor) when the corresponding operation is performed. As shown in FIG. 21A, if the user performs the grid grind operation of the scanner in a right direction, as shown in FIG. 21B, the electronic map is enlarged.

The grid grind operation is an operation that rotates the scanner, and the grid grind operation in the right direction is referred to as ‘grid grind right’.

Specifically, the central processing unit (CPU) of the personal computer recognizes that the grid grind operation is performed when, in an inclined state where an imaging optical axis keeps a predetermined inclination with respect to the vertical line of the surface of the medium, a change in the inclined state of the imaging optical axis is recognized according to the rotation around the vertical line.

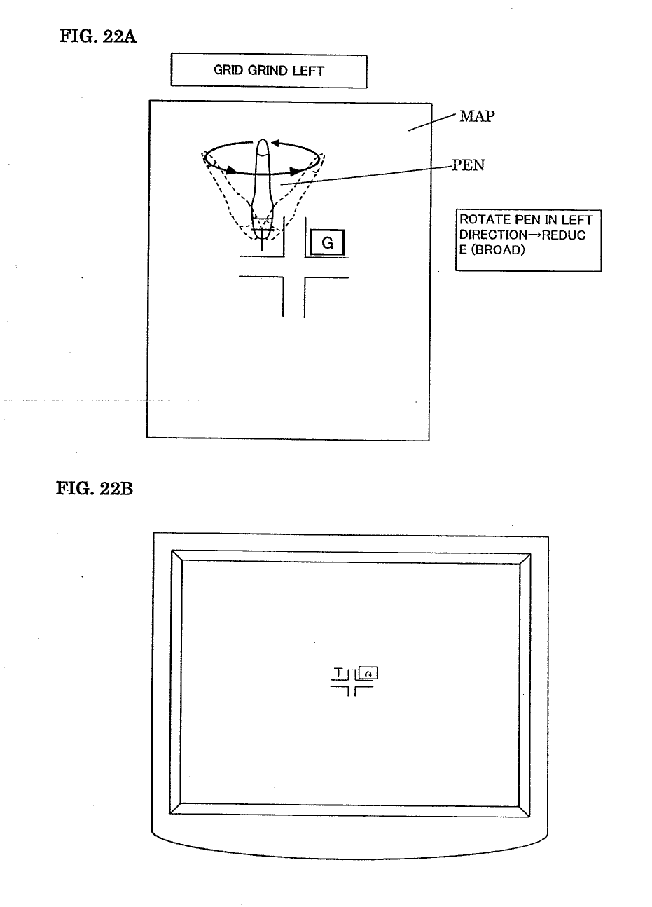

FIGS. 22A and 22B are diagrams illustrating an operation of the scanner for reducing the screen displayed on the display (monitor) by a grid grind operation.

FIG. 22A is a diagram showing an operation that is performed on the map by the user, and FIG. 22B is a diagram showing a video that is displayed on the display (monitor) when the corresponding operation is performed. As shown in FIG. 22A, if the user performs the grid grind operation of the scanner in a left direction, as shown in FIG. 22B, the electronic map is reduced.

As such, the grid grind operation in the left direction is referred to as ‘grid grind left’.

### Second Embodiment

### Three-Dimensional Map

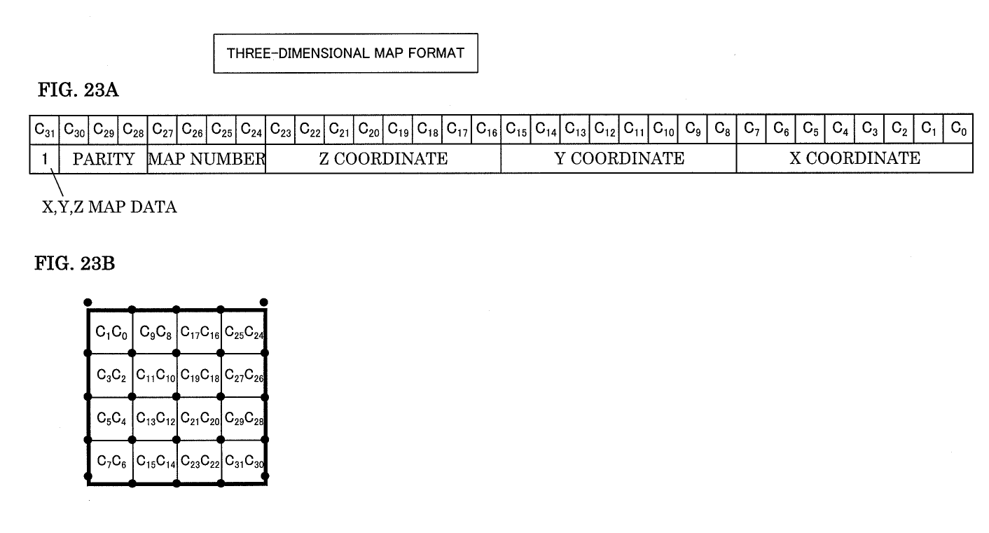

FIGS. 23A to 31C relate to a second embodiment of the invention and illustrate display of a three-dimensional map when an electronic map is a three-dimensional map.

In this embodiment, like the planar map, a map on which dot patterns are superimposed and printed is also used in connection with an electronic apparatus, such as a computer or the like. That is, if an arbitrary point on the map, such as a mountain or a pond is clicked using the scanner, a three-dimensional image corresponding to that point is displayed on the display (monitor).

FIGS. 23A and 23B show the relationship between a dot pattern printed on the surface of the map, and a code value and an XYZ coordinate value.

FIG. 23A shows values, which are defined by 32 bits of C₀ to C₃₁ of the dot pattern, by a table. C₀ to C₇ represent X coordinates, C₈ to C₁₅ represent Y coordinates, C₁₆ to C₂₃ represent Z coordinates, C₂₄ to C₂₇ represent map numbers, C₂₈ to C₃₀ represent parity bits, and C₃₁ represents XYZ map data.

Moreover, C₂₄ to C₂₇ are not limited to map numbers, but may represent other codes (code value).

These values are disposed in lattice regions shown in FIG. 23B.

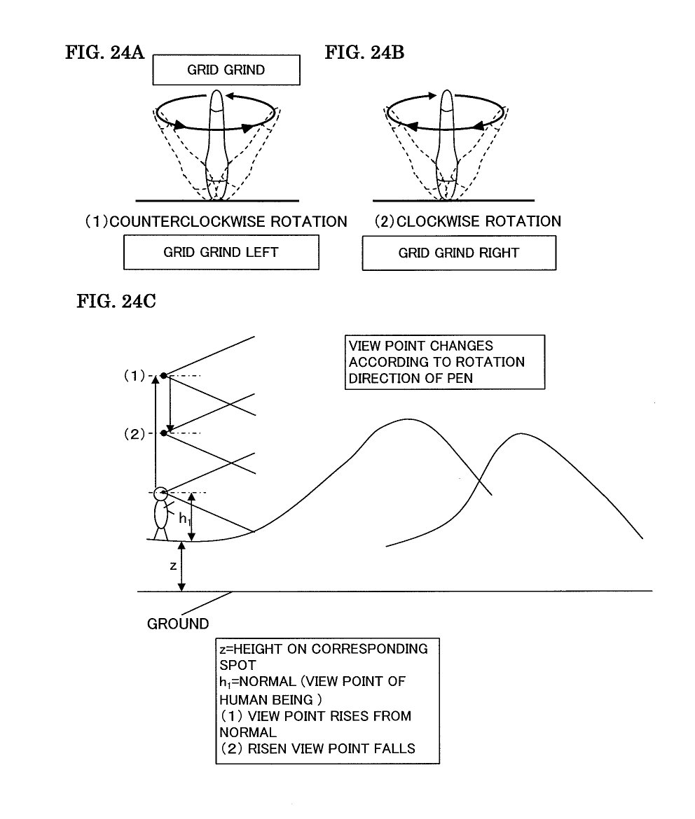

FIGS. 24A to 24C are diagrams illustrating an operation that changes a view point by the above-described grid grind operation.

FIG. 24A is a diagram illustrating a case where the scanner rotates in a counterclockwise direction, FIG. 24B is a diagram illustrating a case where the scanner rotates in a clockwise direction, and FIG. 24C is a diagram illustrating a change in view point in FIGS. 24A and 24B.

In FIG. 24C, Z denotes an altitude at a point clicked by the user. If the user clicks an arbitrary point, a scene viewed from the point clicked by the user is displayed on the display device (monitor) as a three-dimensional image. In this case, a view point becomes Z+h₁ as the sum of the altitude and the height of human's eyes, and this view point becomes a normal view point. As shown in FIG. 24A, if the user rotates the scanner in the counterclockwise direction, the view point rises to a position (1). Then, as shown in FIG. 24B, if the scanner rotates in the clockwise direction, the risen view point falls.

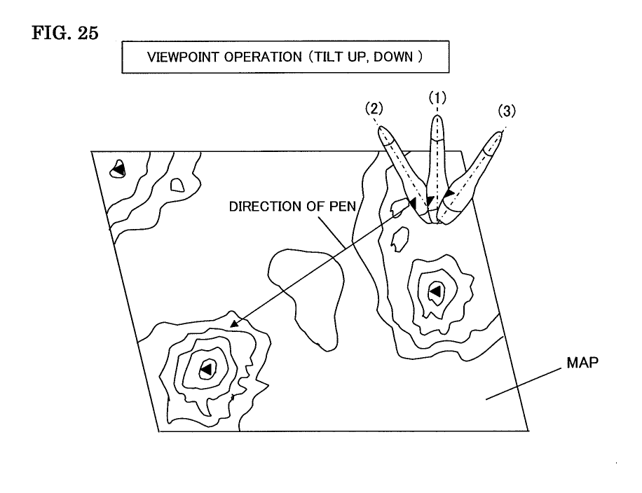

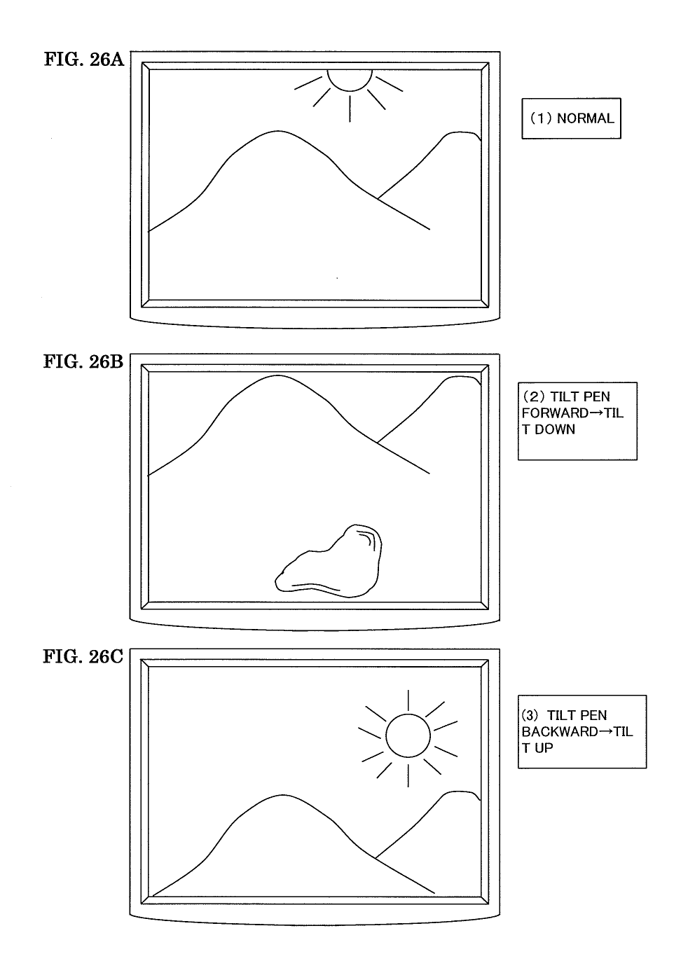

FIGS. 25 and 26A to 26C are diagrams illustrating an operation that tilts up or down the view point according to the orientation of the scanner.

FIG. 25 is a diagram illustrating a user's operation on the map. As indicated by (1), the user first places the scanner perpendicularly to the map. Then, as shown in FIG. 26A, the electronic map is displayed on the display (monitor) in a normal mode. As indicated by (2) of FIG. 25, if the user inclines the scanner forward, as shown in FIG. 26B, the view point moves downward as if a person's posture falls forward. Further, as indicated by (3) of FIG. 25, if the scanned is inclined backward, as shown in FIG. 26C, the view point moves upward as if a person pulls back his/her upper part.

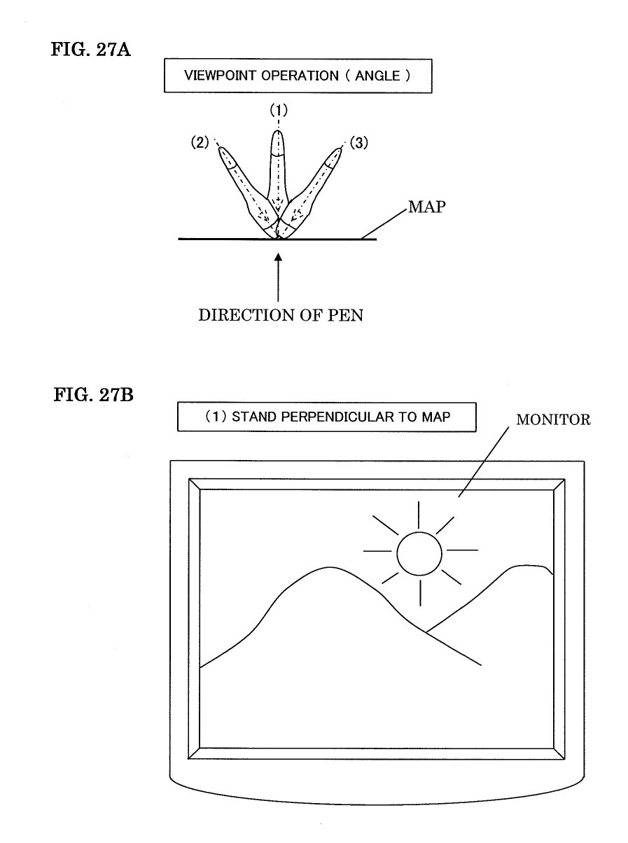

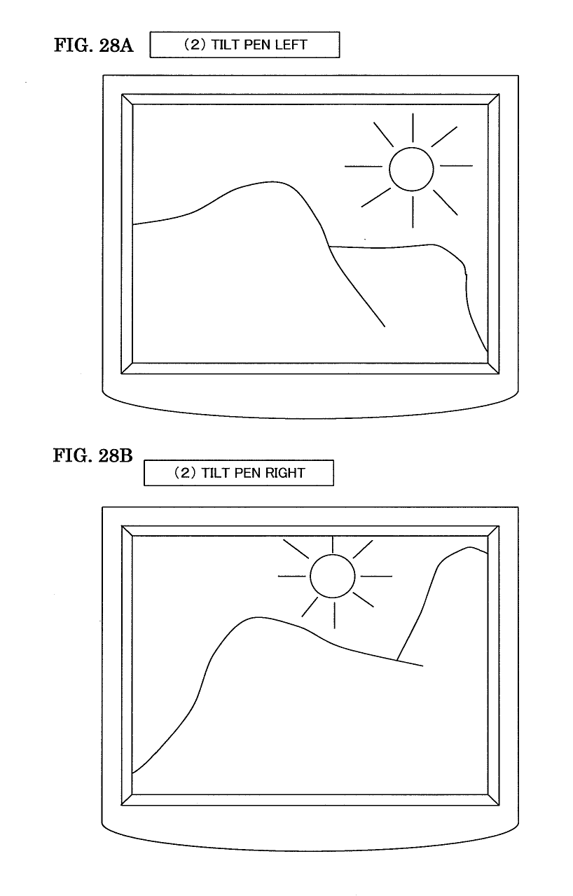

FIGS. 27A to 28B are diagrams illustrating an operation that changes an angle by inclining the scanner left or right.

In FIG. 27A, (1) shows a state where the scanner stands upright with respect to the map, (2) shows a state where the scanner is inclined left, and (3) shows a state where the scanner is inclined right.

In the state (1), the three-dimensional map is displayed on the display (monitor) in a normal mode. As indicated by (2), if the user inclines the scanner left, as shown in FIG. 28A, a screen is displayed in a state where the view point moves left. As indicated by (3), if the user inclines the scanner right, as shown in FIG. 28B, a screen is displayed in a state where the view point moves right.

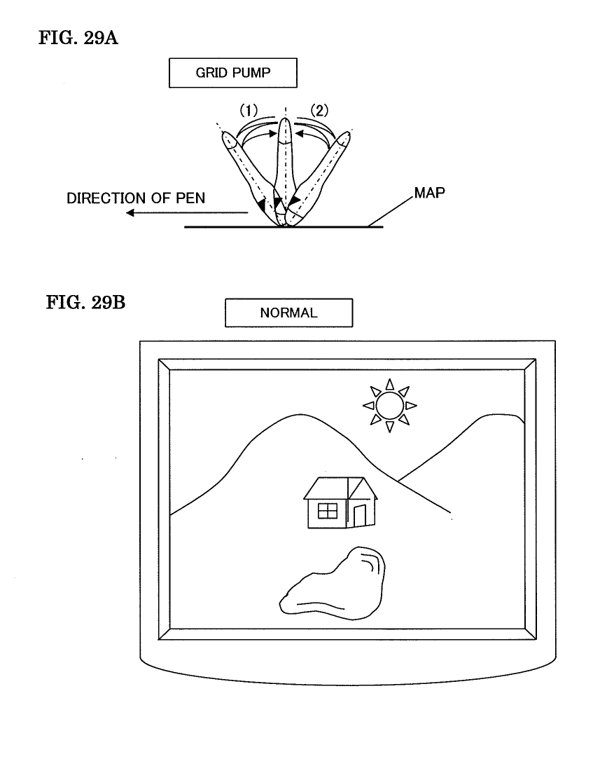

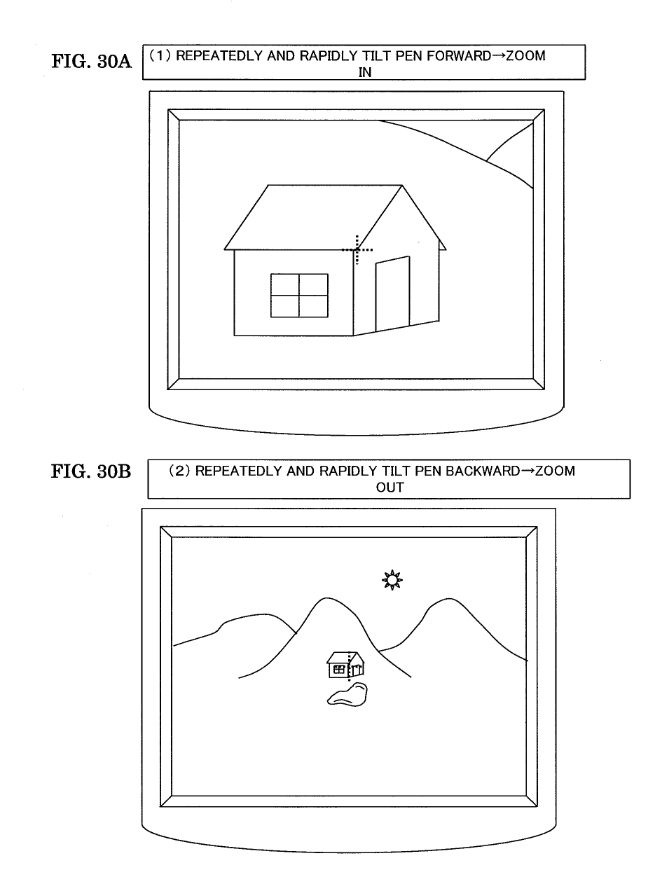

FIGS. 29A to 30B are diagrams illustrating an operation that changes a magnification of the map displayed on the screen by a grid pump operation.

The grid pump operation is an operation that quickly the scanner forward or backward repeatedly. Before the grid pump operation is performed, as shown in FIG. 29B, the same screen as an image when a normal lens of the camera is captured is displayed on the display (monitor). As indicated by (1) of FIG. 29A, if the user quickly inclines the pen forward repeatedly, as shown in FIG. 30A, the image is gradually enlarged, and the same screen as an image captured using a telephoto lens is displayed. Further, as indicated by (2) of FIG. 29A, if the pen is quickly inclined backward repeatedly, a field angle is gradually widened and, as shown in FIG. 30B, a screen when an image is captured using a wide lens is displayed.

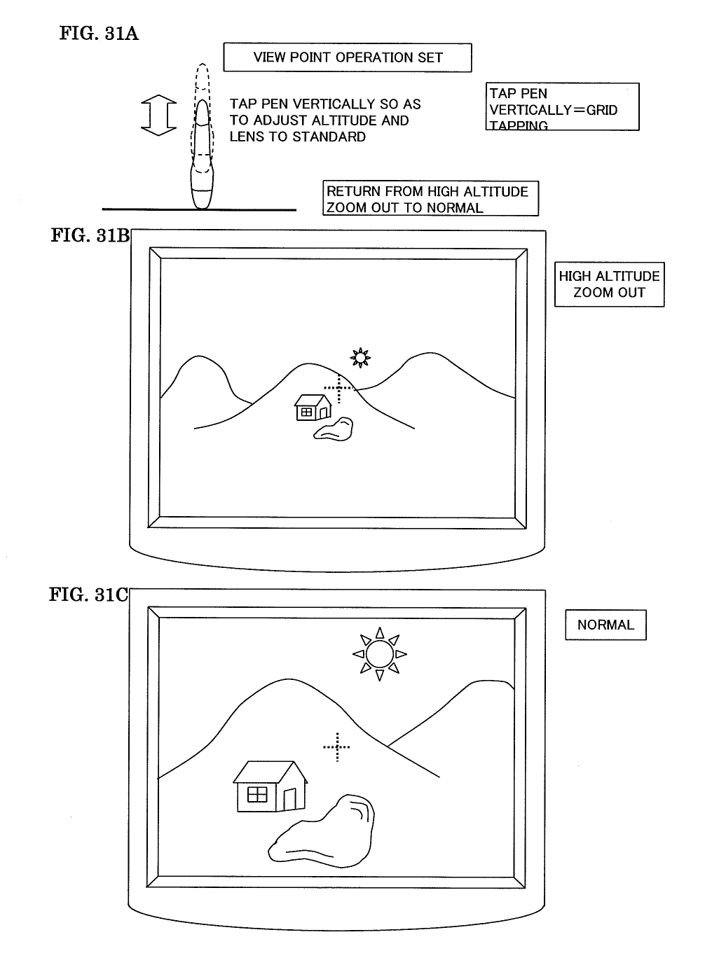

FIGS. 31A to 31C are diagrams illustrating an operation that resets a view point operation by the grid tapping operation.

The grid tapping operation is an operation that stands the scanner perpendicularly to the map and hits against the map while moving the scanner up and down.

For example, as shown in FIG. 31B, it is assumed that a screen captured by the wide lens at a high-altitude position by the above-described grid pump operation is displayed. In this case, as shown in FIG. 31A, if the grid tapping operation is performed, as shown in FIG. 31C, the display mode is reset to the normal mode.

Even in a telephoto mode by the grid pump operation, similarly, the display mode is reset to the normal mode.

Even when the view point changes by the grid grind operation described with reference to FIGS. 24A to 24C, the view point is reset by the grid tapping operation.

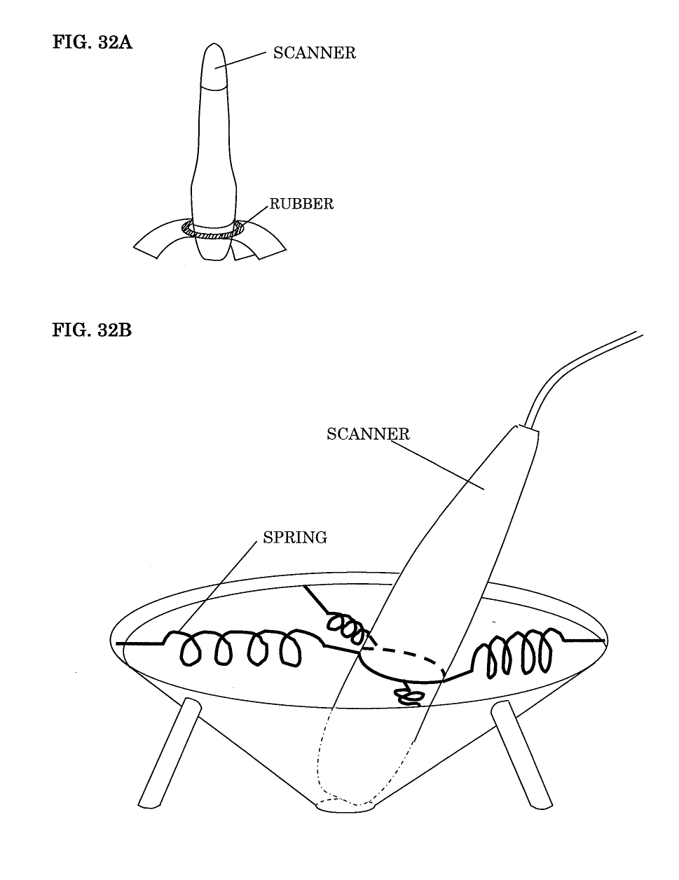

FIGS. 32A and 32B show another embodiment of the scanner.

FIG. 32A shows a state where the scanner is fixed by a tripod tool. An opening is provided at the center of the tool, and rubber is formed around the opening. The scanner is inserted into the opening in use. With this structure, when the user performs an operation, such as a grid grind or the like, the scanner can be fixed, and the sensor unit can be prevented from reading a dot pattern other than a target dot pattern.

FIG. 32B shows a state where the scanner is fixed by springs in a cup-like tool. Openings are provided at upper and lower parts of the tool, and a plurality of springs are provided at the upper part. The scanner is fixed by the springs in use.

In the known scanner, when the user performs various operations using the scanner, a bottom part slightly moves during rotation, and the dot pattern cannot be accurately read. In contrast, with the above-described structure, the bottom part is fixed, and thus the dot pattern can be accurately read. Further, with rubber or springs, the user can smoothly perform the operation.

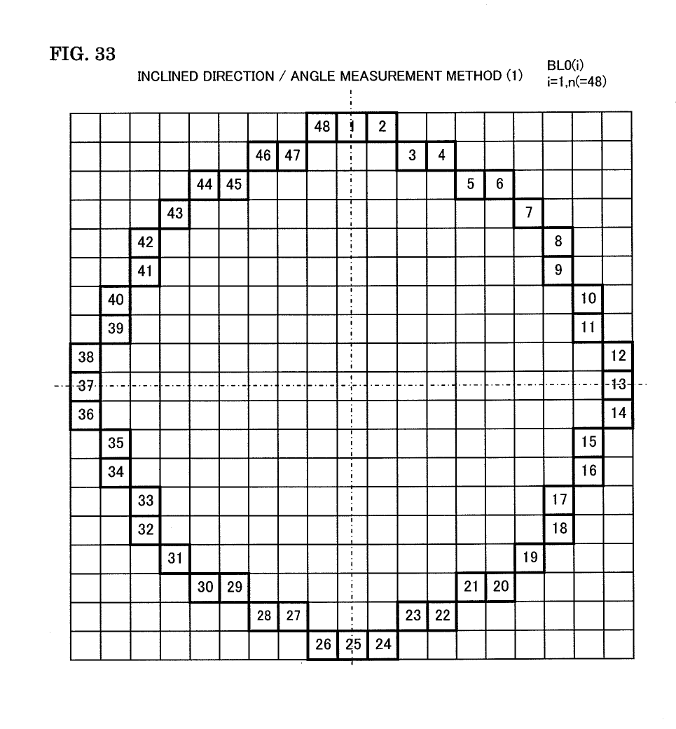

FIGS. 33A to 37 are diagrams illustrating a method of calculating an inclination direction when the scanner is inclined.

The inclination of the scanner with respect to the vertical direction of the surface of the medium (map) can be recognized by a difference in brightness in imaging field of the scanner, as shown in FIG. 20B.

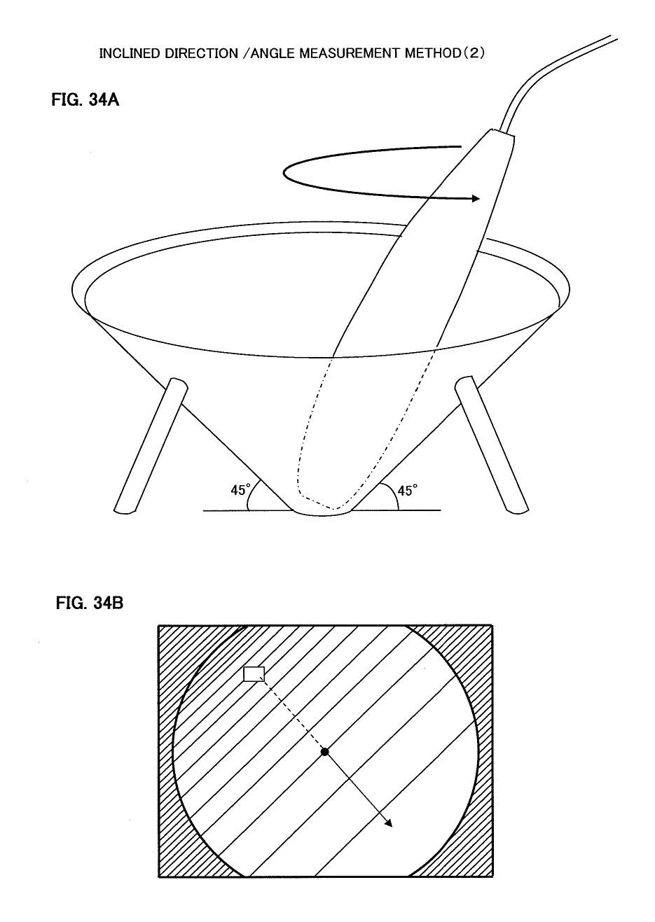

The inclination direction of the scanner refers to an angle between the scanner and the map, as shown in FIG. 34A. Which direction the user inclines the scanner can be calculated by the following method.

First, calibration is performed. The scanner stands upright with respect to the map, and then brightness of cells 1 to 48 shown in FIG. 33 is measured. FIG. 33 shows a region around the scanner. It is assumed that brightness at that time is BL0(i). i is the value of the measured cell. For example, brightness of the 24th cell is represented by BL0(24).

In the scanner, two LEDs are provided. For this reason, even though the scanner stands upright with respect to the map, there is a difference in brightness between a cell around the LED and a cell spaced from the LED. Accordingly, the calibration is performed.

Next, brightness when the scanner is inclined is measured. As shown in FIG. 34B, brightness of the cells 1 to 48 when the scanner is inclined in a predetermined direction is measured. It is assumed that brightness of the cell i is BL(i). Next, a difference between BL(i) and BL0(i) in each cell is measured. Next, the following is calculated.

Max(BL0(i)−BL(i))

When the scanner is inclined, a direction opposite to the inclination direction is darkened. This is because the LED is also inclined in the inclination direction of the scanner, and thus the distance from the LED becomes more distant in the direction opposite to the inclination direction. Accordingly, as shown in FIG. 34B, a direction opposite to the cell having the maximum difference becomes a position where the scanner is inclined.

Then, the inclination direction of the scanner is determined.

FIGS. 33A to 34B show another method of determining the inclination direction and the angle by performing the calibration.

Initially, the calibration is performed. First, the scanner stands upright with respect to the map, and brightness of the cells 1 to 48 shown in FIG. 33A is measured. It is assumed that brightness in the cell i is BL0(i).

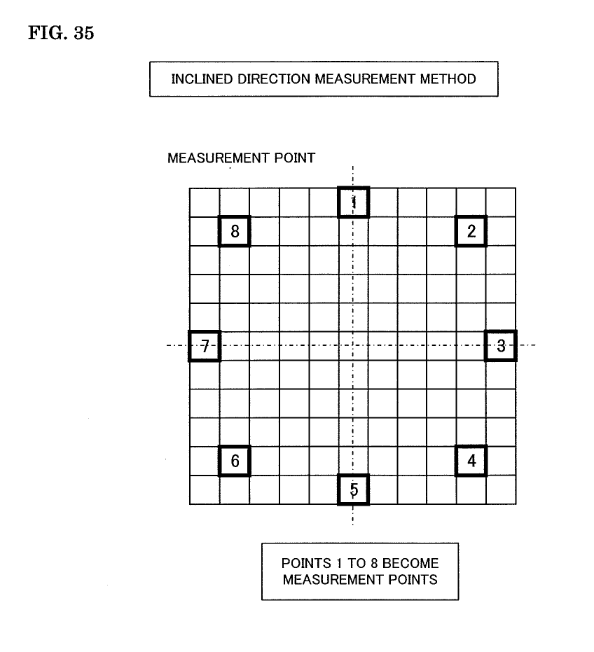

Next, the scanner is inclined by 45°, and goes round with the tip of the pen as an axis, as shown in FIG. 35. In this case, it is assumed that brightness when the scanner is located at a position of the cell i is BL45(i). BL45(i) from the cells 1 to 48 are measured. With the above operations, the calibration is completed.

Next, when the user inclines the scanner, brightness of the cells 1 to 48 is measured. It is assumed that brightness of the cell i is BL(i), and i=1, n(48). Next, the following is calculated.

$$Max \frac{BL 0 ( i ) - BL ( i )}{BL 0 ( i ) - BL 45 ( i )} , \\ i = 1 , n = 1 , n ( = 48 ) \qquad Equation 1$$

Since BL0(i)−BL45(i) is constant, when the value of BL0(i)−BL(i) has the maximum, that is, when BL(i) has the minimum, the following has the maximum.

$$\frac{BL 0 ( i ) - BL ( i )}{BL 0 ( i ) - BL 45 ( i )} , \\ i = 1 , n = 1 , n ( = 48 ) \qquad Equation 2$$

As described above, since the direction opposite to the inclination direction of the scanner is most darkened, the direction opposite to the cell i in this case becomes the inclination direction of the scanner.

The inclination angle of the scanner is as follows.

$$θ = 45 \times \frac{BL 0 ( i ) - BL ( i )}{BL 0 ( i ) - BL 45 ( i )} , \\ i = 1 , n = 1 , n ( = 48 ) \qquad Equation 3$$

In the above-described equation, it is assumed that an angle θ is linear with respect to brightness, but strictly, the following approximation using a trigonometrical function results in an increase in accuracy. Then, the angle is as follows.

$$θ = \frac{1}{2} {cos}^{- 1} [ \frac{BL ( i ) - BL 45 ( i )}{BL 0 ( i ) - BL 45 ( i )} ] \qquad Equation 4$$

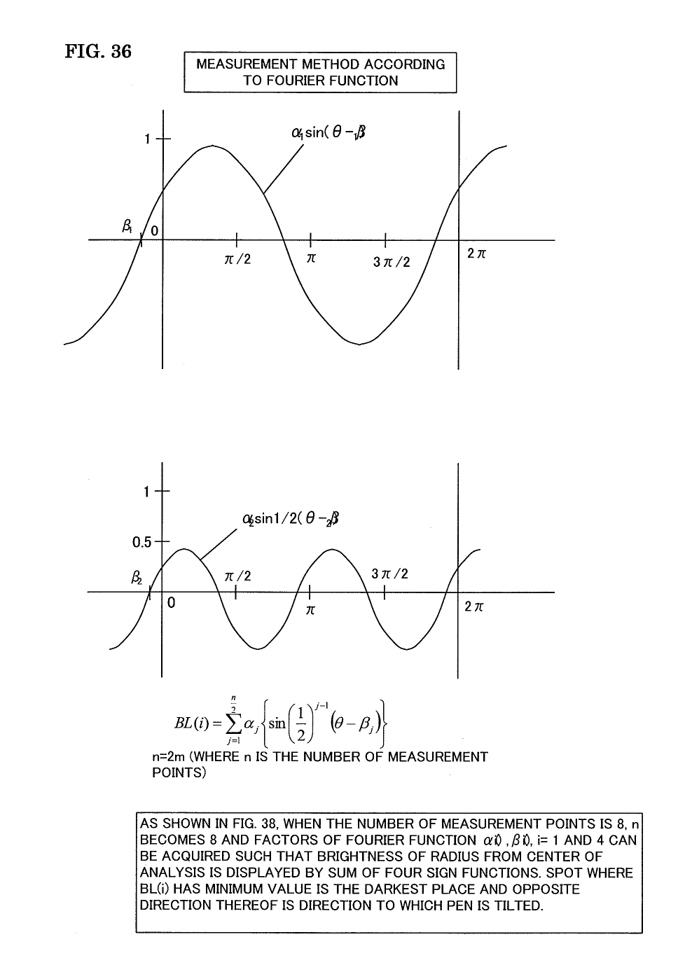

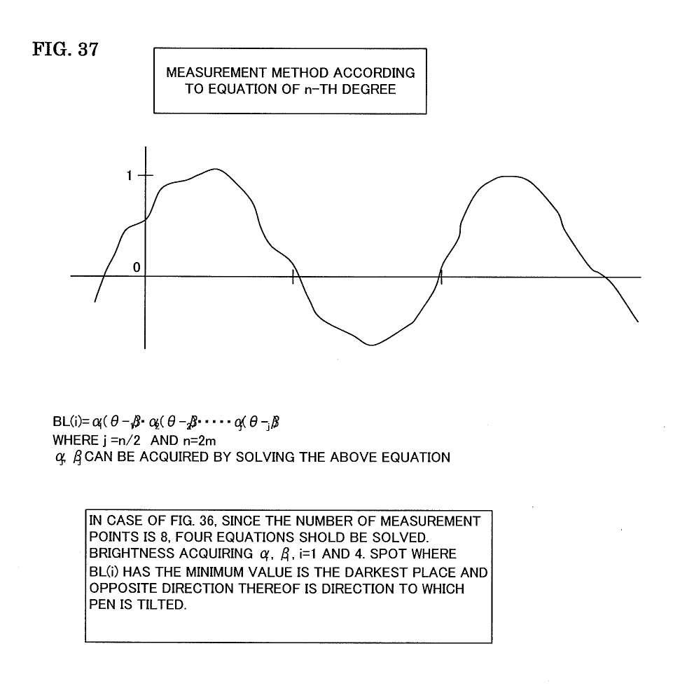

FIG. 36 shows a method of measuring the inclination direction using a Fourier function.

As shown in FIG. 35, eight cells of the cells 1 to 8 are selected as measurement points, and brightness of each cell is measured.

A sine function is represented as follows.

αj{sin(½)j−1(θ−βj)}

That is, the number of unknown quantities is two.

Therefore, when n measurement points are provided, the number of discrete points becomes n. Accordingly, the sum of n/2 sine functions is calculated, and this becomes brightness BL(i) at a radius from the analysis center. That is, the following is represented.

$$BL ( i ) = {\sum }_{j = 1}^{\frac{n}{2}} {α}_{j} \{ {sin ( \frac{1}{2} )}^{j - 1} ( θ - {β}_{j} ) \} \qquad Equation 5$$

However, n=2m (where n is the number of measurement points).

In this embodiment, since the number of measurement points is 8, n=8. Accordingly, α1 to α4 and β1 to β4 of Fourier series are calculated by synthesizing equations of four sine functions. Then, brightness BL(i) at the radius from the analysis center is represented by the sum of the four sine functions.

From the above equation, the angle θ having the minimum BL(i) becomes the darkest position, and a direction opposite thereto by 180 degrees becomes the inclination direction of the scanner.

FIG. 37 shows a method of measuring the inclination direction by analyzing an equation of the n-th degree.

A graph of FIG. 37 shows a function of the n-th degree. When the function of the n-th degree is used, brightness BL(i) at the radius from the analysis center is as follows.

BL(i)=α1(θ−β1)·α2(θ−β2) . . . αj(θ−βj)

However, j=n/2 and n=2m.

As shown in FIG. 35, in this embodiment, since the number of measurement points is 8, it is necessary to calculate eight solutions. Since two unknown quantities of αj and βj are included in one equation, four solutions of the equation are calculated, and then α1 to α4 and β1 to β4 are calculated.

Accordingly, the angle θ at which BL (i) becomes the minimum is calculated. A position having an angle θ is the darkest position, and a direction opposite thereto by 180 degrees becomes the inclination direction of the scanner.

In the measurement method according to FIGS. 36 and 37, the inclination of the scanner with respect to the vertical line of the map cannot be measured. Then, in connection with the measurement method shown in FIGS. 33A to 34B, the inclination angle can be specifically measured.

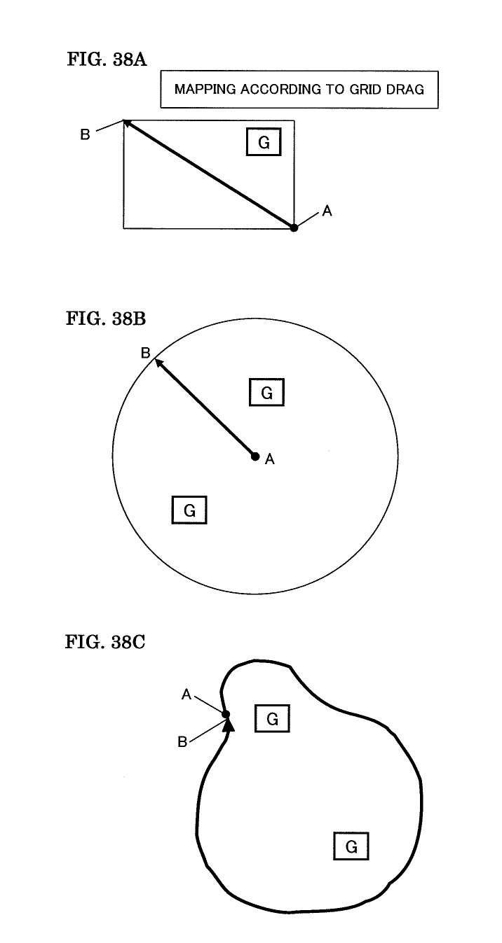

FIGS. 38A to 38C are explanatory views showing another embodiment of the search function of facilities and the like described with reference to FIGS. 15A and 15B.

In this embodiment, if the user performs the grid drag operation, a designated range is determined on the basis of the trace, and a facility or the like designated by the user is searched in that range.

In FIG. 38A, A is a start point and B is an end point. If the user drags from A to B as arbitrary points in the map portion, the coordinate values of A and B are recognized, and a rectangle or a square having a diagonal AB becomes the designated range. After the grid drag operation is performed, if the icon of a desired facility, such as ‘GS’, ‘ATM’, and the like printed on the icon portion, is clicked, only the facilities within the designated range among the facilities are displayed.

In FIG. 38B, if the user drags from A to B as arbitrary points in the map portion, a circle having a radius AB becomes the designated range. Further, in FIG. 38C, if the user draws an arbitrary shape such that the start point and the end point are consistent with each other, the shape becomes the designated range.

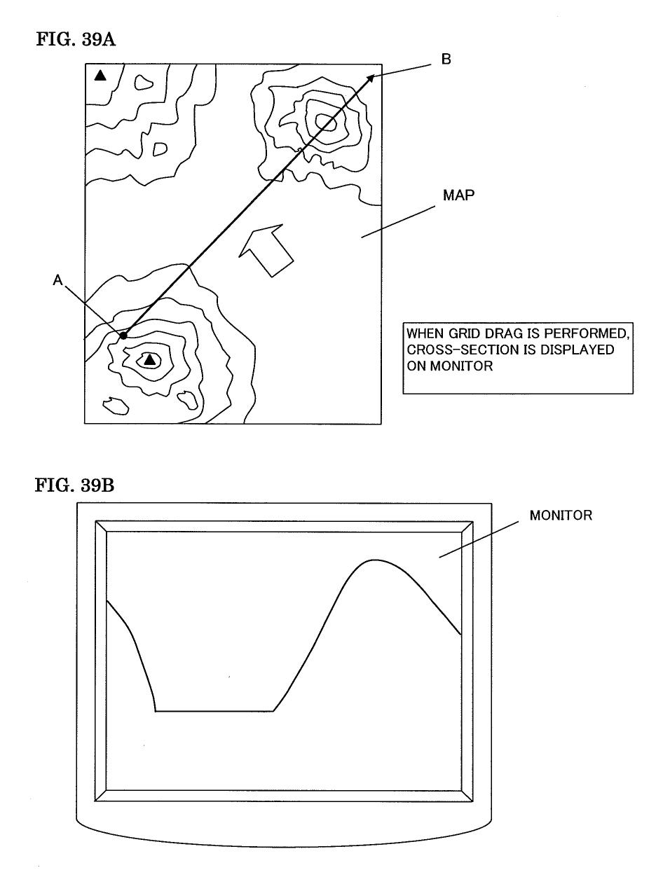

FIGS. 39A and 39B are explanatory views showing a method of displaying a section by the grid drag operation in the three-dimensional map.

FIG. 39A is a diagram showing an operation that is performed on the map by the user, and FIG. 39B is a diagram showing a screen that is displayed on the display (monitor) when the corresponding operation is performed. As shown in FIG. 39A, the user performs the grid drag operation with the start point A and the end point B. Then, as shown in FIG. 39B, a cross-sectional view taken along the line AB is displayed on the display (monitor). As described with reference to FIGS. 23A and 23B, the map has the XY coordinates and the Z coordinate, and thus the cross-sectional view is easily generated on the basis of the Z coordinate with respect to the XY coordinates in the line AB.

1. An information output apparatus for a medium, on which dot patterns based on predetermined rules are printed in concurrence with printing, the information output apparatus comprising:
an imaging unit that reads the dot patterns on a surface of the medium;
a converting unit that converts a captured image obtained by the imaging unit into code values or coordinate values indicated by the dot patterns; and
an output unit that outputs information corresponding to the code values or the coordinate values,
wherein the apparatus has, on at least one surface thereof, a multi-information region where a dot pattern obtained by patterning coordinate information and a dot pattern obtained by patterning code information are printed,
when the imaging unit reads the coordinate information from the dot pattern in the multi-information region on the surface of the medium, the converting unit reads information associated with the coordinate information from a storage unit, and the output unit outputs the information, and
when the imaging unit reads the code information from the dot pattern in the multi-information region on the surface of the medium, the converting unit reads information associated with the code information from the storage unit, and the output unit outputs the information.

2. The information output apparatus according to claim 1,
wherein an icon figure on which a dot pattern for mode switching on whether to read and output information corresponding to the code information read from the dot pattern in the multi-information region from the storage unit or to read and output information corresponding to the coordinate information from the storage unit is printed is printed on the surface of the medium.

3. The information output apparatus according to claim 2,
wherein the coordinate information on the surface of the medium has at least XY coordinates and a Z coordinate, and the storage unit stores information corresponding to the XY and Z coordinates.

4. The information output apparatus according to claim 1,
wherein an icon figure, on which code information for up and down or left and right movement for moving, on the output unit, image information output from the output unit is patterned and printed, is further printed on the surface of the medium.

5. The information output apparatus according to claim 1,
wherein an icon figure, on which code information for enlarging or reducing, on the output unit, image information output from the output unit is patterned and printed, is further printed on the surface of the medium.

6. An information output apparatus for a medium, on which dot patterns based on predetermined rules are printed in concurrence with printing, the information output apparatus comprising:
an imaging unit that reads the dot patterns on a surface of the medium;
a converting unit that converts a captured image obtained by the imaging unit into code values or coordinate values indicated by the dot patterns; and
an output unit that outputs information corresponding to the code values or the coordinate values,
wherein the apparatus has, on at least one surface thereof, a medium where the dot pattern obtained by patterning the coordinate information is superimposed and printed and
a multi-information region where the dot pattern obtained by patterning the code information is superimposed and printed on the surface of the medium, together with at least the coordinate information,
when the imaging unit reads the coordinate information and the code information from the dot patterns in the multi-information region on the surface of the medium, the converting unit reads information corresponding to the coordinate information and the code information from a storage unit, and the output unit outputs the information, and
output information is switched according to the read operation of the dot pattern on the surface of the medium by the imaging unit.

7. The information output apparatus according to claim 6,
wherein the switching of the output information is switching between output information based on the coordinate information and output information based on the code information, switching of the output information in the coordinate information or the code information, or resetting of the output information.

8. The information output apparatus according to claim 6,
wherein the switching of the output information is performed when the substantially same XY coordinate information or code information in a predetermined time is read multiple times by a grid tapping operation of the imaging unit on the surface of the medium.

9. The information output apparatus according to claim 6,
wherein the switching of the output information is performed when XY coordinate information read in a predetermined time is recognized as a substantially circular trace by a circular grid sliding operation of the imaging unit on the surface of the medium.

10. The information output apparatus according to claim 6,
wherein the switching of the output information is performed when XY coordinate information read in a predetermined time is recognized as a substantially linear trace by a linear grid scroll operation of the imaging unit on the surface of the medium.

11. The information output apparatus according to claim 6,
wherein the switching of the output information is performed when a trace of XY coordinates read in a predetermined time is recognized as a repetition of a linear trace of a short length by a grid scratch operation of the imaging unit on the surface of the medium.

12. The information output apparatus according to claim 6,
wherein the switching of the output information is performed when a grid tilt operation of the imaging unit, that is, an inclination of an imaging optical axis with respect to a vertical line of the surface of the medium is recognized.

13. The information output apparatus according to claim 12,
wherein the switching of the output information is performed when a grid grind operation of the imaging unit, that is, in an inclined state where the imaging optical axis is kept at a predetermined inclination with respect to a vertical line of the surface of the medium, a change in the inclined state of an imaging optical axis is recognized by rotating around the vertical line.

14. The information output apparatus according to claim 12,
wherein the inclination is recognized by a difference in brightness in an imaging field of the imaging unit.

15. The information output apparatus according to claim 6,
wherein the medium is a map, and
the switching of the output information is switching from the map to information, switching of layers of the map, continuous switching of enlargement or reduction of the map, continuous switching of a display position of the map to XY directions, and switching of a sight line.

16. The information output apparatus according to claim 6,
wherein the medium is a map on which a dot pattern obtained by patterning three-dimensional map information by XYZ coordinates as coordinate information is superimposed and printed, and
the output information displays a three-dimensional map image generated on the basis of the XYZ coordinates with respect to a fixation point viewed from a view point on a display device as the output unit by continuously switching the fixation point, an angle, or a viewing angle.

17. The information output apparatus according to claim 16,
wherein the switching of the output information continuously switches an altitude of a viewpoint so as to display a corresponding three-dimensional map image on a display device as the output unit.
